(19) United States
(12) Patent Application Publication
(10) Pub. No.: US 2026/0046873 A1
(43) Pub. Date: Feb. 12, 2026

(54) TECHNIQUES TO FACILITATE RADIO RESOURCE CONTROL MESSAGE SEGMENTATION

(71) Applicant: QUALCOMM Incorporated, San Diego, CA (US)

(72) Inventors: Uttam VYAS, Hyderabad (IN); Surbhi AGARWAL, Bengaluru (IN); Bapineedu Chowdary GUMMADI, Hyderabad (IN)

(21) Appl. No.: 19/099,457

(22) PCT Filed: Sep. 11, 2023
(86) PCT No.: PCT/US2023/032436

§ 371 Date: Jan. 28, 2025

(30) Foreign Application Priority Data
Sep. 16, 2022 (IN) 202241053030

(51) Int. Cl. H04W 72/21; H04B 17/309; H04B 17/318; H04W 72/51; H04W 76/20; H04W 76/30

(52) U.S. Cl. CPC H04W 72/21; H04B 17/328; H04B 17/346; H04W 72/51; H04W 76/20; H04W 76/30

(57) ABSTRACT

Apparatus, methods, and computer-readable media for facilitating RRC message segmentation are disclosed herein. An example method for wireless communication at a user equipment (UE) includes receiving, from a network, an indication enabling segmentation of uplink control messages. The example method also includes transmitting an uplink control message based on uplink control information to the network without the segmentation based on at least one of a channel condition or a count of connection releases from the network. In some examples, the uplink control information may have a size that is greater than a maximum PDCP SDU size.

### CROSS-REFERENCE TO RELATED APPLICATION

This application claims the benefit of India patent application No. 202241053030, entitled “TECHNIQUES TO FACILITATE RADIO RESOURCE CONTROL MESSAGE SEGMENTATION” and filed on Sep. 16, 2022, which is expressly incorporated by reference herein in its entirety.

### TECHNICAL FIELD

The present disclosure relates generally to communication systems, and more particularly, to wireless communication employing message segmentation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may receive, from a network, an indication enabling segmentation of uplink control messages. The example apparatus may also transmit an uplink control message based on uplink control information to the network without the segmentation based on at least one of a channel condition or a count of connection releases from the network, the uplink control information having a size that is greater than a maximum packet data convergence protocol (PDCP) service data unit (SDU) size.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example communication flow between a network entity and a UE, in accordance with various aspects of the present disclosure.

FIG. 5 is a diagram illustrating an example segmentation procedure for an uplink control message, in accordance with various aspects of the present disclosure.

FIG. 6 illustrates an example communication flow between a network entity and a UE, in accordance with various aspects of the present disclosure.

FIG. 7 includes pseudocode that may facilitate a UE to determine whether to employ message segmentation for an uplink control message based on serving cell conditions, in accordance with various aspects of the present disclosure.

FIG. 8 illustrates an example communication flow between a network entity and a UE, in accordance with various aspects of the present disclosure.

FIG. 9 illustrates an example communication flow between a network entity and a UE, in accordance with various aspects of the present disclosure.

FIG. 10 includes pseudocode that may facilitate a UE to determine whether to employ message segmentation for an uplink control message based on network behavior causing the network to output immediate connection release messages, in accordance with various aspects of the present disclosure.

FIG. 11 illustrates an example communication flow between a network entity and a UE, in accordance with various aspects of the present disclosure.

FIG. 12 illustrates an example communication flow between a network entity and a UE, in accordance with various aspects of the present disclosure.

FIG. 13 depicts a table illustrating different actions taken by a UE with respect to different instances of capability enquiry messages, in accordance with various aspects of the present disclosure.

FIG. 14 illustrates an example communication flow between a network entity and a UE, in accordance with various aspects of the present disclosure.

FIG. 15 is a flowchart of a method of wireless communication at a UE, in accordance with the teachings disclosed herein.

FIG. 16 is a flowchart of a method of wireless communication at a UE, in accordance with the teachings disclosed herein.

FIG. 17 is a diagram illustrating an example of a hardware implementation for an example apparatus and/or network entity.

### DETAILED DESCRIPTION

Wireless communication systems support the exchange of messages between UEs and networks. For example, a UE may determine information for transmitting, encode the information in a message, and then transmit a communication including the message. In some aspects, the amount of uplink control information encoded in the message may be large, and the size of the message may be undesirably large. For example, the size of the message may exceed a packet size limit. In such scenarios, to satisfy the packet size limit, the UE may be limited in the amount of uplink control information that the UE provides to the network via the message.

In some aspects, the UE may be configured to employ segmentation to transmit the message using segments. For example, the network may provide a segmentation indicator that enables, or disables, message segmentation at the UE for a message, such as an uplink control message. In scenarios in which message segmentation is disabled, the amount of uplink control information that the UE may encode in the uplink control message may be limited so that the size of the uplink control message is not greater than the packet size limit (e.g., the size of the uplink control message is less than or equal to the packet size limit). The UE may then transmit the uplink control message to the network without segmentation.

In scenarios in which message segmentation is enabled, the amount of uplink control information that the UE may encode in the uplink control message is not constrained by the packet size limit for one packet. However, the amount of uplink control information encoded in the uplink control message may or may not satisfy the packet size limit. In examples in which the size of the uplink control message fails to satisfy the packet size limit, the UE may perform message segmentation and transmit the uplink control message via two or more segments. For example, the UE may partition the uplink control message into N segments so that a size associated with each respective segment satisfies the packet size limit. Each of the segments may contain a portion of the uplink control message. The UE may then transmit each of the segments via a segment message to the network.

Thus, message segmentation may enable the UE to provide larger amounts of information. For example, the UE may no longer be constrained by the packet size limit for one packet when encoding an uplink control message.

However, in some examples, employing message segmentation may lead to reduced communication performance between the UE and the network. For example, the UE may retransmit the uplink control message or a segment of the uplink control message (e.g., a segment message) if an acknowledgement (ACK) message is not received from the network after transmitting the uplink control message or the segment message. The retransmission of the uplink control message or the segment message may result in delay times on the network side and/or consume transmission resources at the UE side.

In some examples, when channel conditions are not optimal, transmitting the uplink control message using segmentation may result in the UE employing retransmissions, which may lead to delays in processing of the uplink control message at the network. For example, the network may use information provided via the uplink control message to facilitate performing an attach procedure or a mobility procedure with the UE. In scenarios in which channel conditions are poor, the UE may experience a high uplink/downlink block error rate (BLER) associated with transmitting the uplink control message, which may result in an overall delay at the UE in providing the information of the uplink control message using segmentation.

In some aspects, a network may be unable to handle message segmentation or may not be configured to receive uplink control messages with segmentation. For example, the network may transmit a connection release message when it receives an uplink control message with segmentation (e.g., when the network receives a segment message). In some aspects, the network may maintain a timer associated with receiving an uplink control message with segmentation. In some such examples, if the UE takes too long to send the uplink control message with segmentation, the network may transmit a connection release message. For example, the network may transmit the connection release message upon expiry of the timer.

In some aspects, the UE may stop sending the remaining segments of the uplink control message after receiving the connection release message. As a result, the UE may be unable to provide the information encoded in the uplink control message to the network. Additionally, the network may be unable to provide certain communication services to the UE based on the network not receiving the information encoded in the uplink control message.

Aspects disclosed herein provide techniques for enabling a UE configured with message segmentation enabled to determine whether to employ message segmentation based on at least one of a channel condition or a count of connection releases from the network. For example, the UE may determine to skip employing message segmentation even when message segmentation is permitted based on a size of uplink control information associated with the message. As used herein, the UE may be permitted to employ message segmentation when message segmentation is enabled (e.g., via a segmentation indicator) and the size of uplink control information fails to satisfy the packet size limit (e.g., the size of the uplink control message is greater than the packet size limit). For purposes of this disclosure, failing to satisfy the packet size limit may occur when a size of an uplink control message is greater than the packet size limit or a size of uplink control information associated with the uplink control message is greater than the packet size limit. Thus, the size of the uplink control message and the size of the uplink control information may be used interchangeably.

In some examples, the UE may evaluate channel conditions of a serving cell and determine to transmit the uplink control message without segmentation even when message segmentation is permitted. That is, the size of the uplink control message may fail to satisfy the packet size limit (e.g., the size of the uplink control message is greater than the packet size limit), but the UE may determine to transmit the uplink control message without segmentation based on the channel condition. For example, when the UE determines that the channel condition is poor, the UE may transmit the uplink control message without segmentation. However, when the UE determines that the channel condition is not poor, then the UE may transmit the uplink control message with segmentation.

In some aspects, the UE may be configured to determine whether to employ message segmentation, even when message segmentation is permitted, based on an evaluation of the network and its ability to handle message segmentation. For example, the network may be configured to transmit a connection release message when it receives a segment message or when a timer associated with receiving an uplink control message with segmentation expires. In aspects disclosed herein, the UE may maintain a count of connection release messages received from the network when attempting to transmit uplink control messages with segmentation. In some such examples, when the count of connection release messages is greater than a release threshold, the UE may determine to skip using message segmentation even when message segmentation is permitted (e.g., based on the size of the uplink control message).

For example, before generating an uplink control message, the UE may compare its count of connection release messages to the release threshold. In examples in which the count of connection release messages is less than or equal to the release threshold, the UE may generate the uplink control message without being constrained by the packet size limit for one message. The UE may then transmit the uplink control message with or without segmentation based on the size of the uplink control message. In examples in which the count of connection release messages is greater than the release threshold, the UE may then generate the uplink control message by limiting the amount of uplink control information encoded in the uplink control message based on size of the uplink control message.

In some aspects disclosed herein, after the UE determines to skip employing message segmentation even when permitted, the UE may continue to skip employing message segmentation until the UE detects the occurrence of an update triggering event. In some examples, after detecting the occurrence of an update triggering event, the UE may be configured to transmit an update message to the network. The update message may inform the network to perform a resynchronization procedure with the UE. For example, the network may output a capability enquiry message after receiving the update message.

In some examples, the UE may detect the occurrence of the update triggering event based on a change in channel conditions. For example, if the UE determines to skip employing message segmentation after determining that the channel conditions are poor, the UE may detect the occurrence of an update triggering event after determining a change in the channel conditions (e.g., the channel conditions are no longer poor or are good). In other examples, the UE may detect the occurrence of an update triggering event after performing a mobility procedure to another serving cell with better channel conditions.

In examples in which the UE determines to skip employing message segmentation based on the count of connection release messages, the UE may detect the occurrence of an update triggering event based on a change in its connection with the network. For example, the UE may detect the occurrence of the update triggering event in response to a change in at least one of a serving cell, a tracking area, or a serving network node. In some examples, the UE may determine a change in the tracking area based on a change in a tracking area identifier (TAI) and/or a change in a registration area (RA).

The aspects presented herein may enable a UE to improve communication performance in scenarios in which message segmentation is permitted. For example, in poor channel conditions, avoiding message segmentation may reduce overhead associated with uplink transmission, which can avoid or reduce delays associated with procedures based on information provided by the UE via an uplink control message, such as an attach procedure. Avoiding message segmentation in poor channel conditions may also reduce the possibility of connection drops due to a missing acknowledgement message from the network after the UE transmits the uplink control message.

In examples in which the UE avoids message segmentation based on a count of connection release messages, the UE may be able to improve communication performance by maintaining a connection with the network. For example, if the network is performing immediate connection releases after the UE transmits a segment message, the UE may have the ability to determine, based on the count of connection release messages, that the network is unable to handle message segmentation. In such examples, the UE may skip message segmentation when communicating with the network to maintain the connection with the network.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

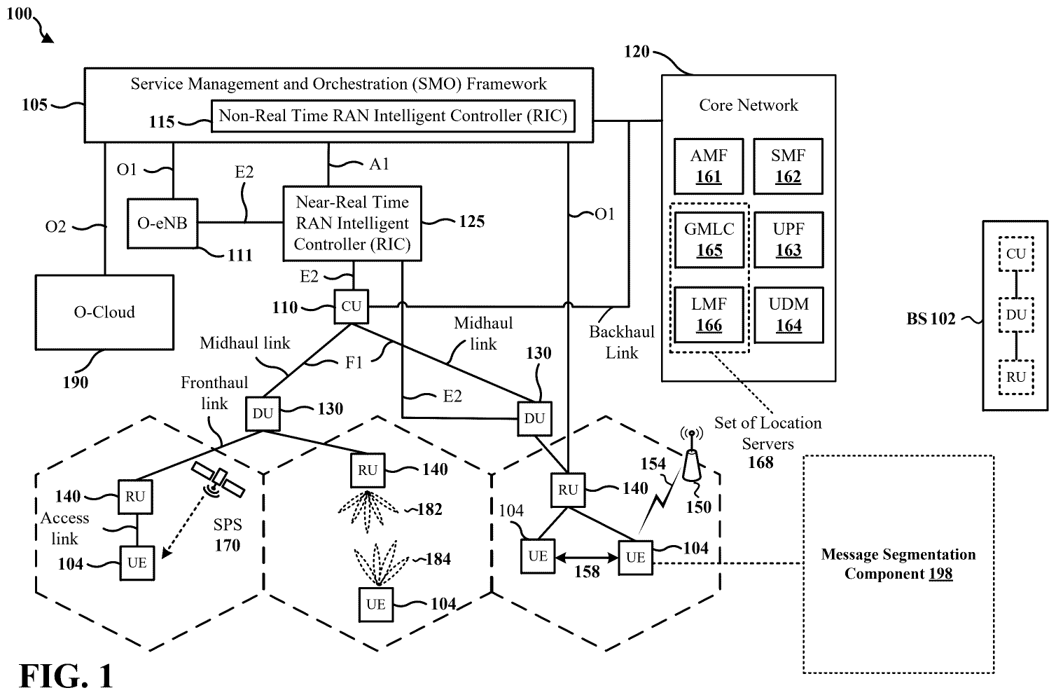

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs. Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-cNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a message segmentation component 198 configured to facilitate performing message segmentation based on channel conditions and/or network abilities, in addition to a message size.

In certain aspects, the message segmentation component 198 may be configured to receive, from a network, an indication enabling segmentation of uplink control messages. The example message segmentation component 198 may also be configured to transmit an uplink control message based on uplink control information to the network without the segmentation based on at least one of a channel condition or a count of connection releases from the network, the uplink control information having a size that is greater than a maximum packet data convergence protocol (PDCP) service data unit (SDU) size.

The aspects presented herein may enable a UE to skip employing message segmentation even when permitted, which may facilitate improving communication performance, for example, by reducing overhead associated with uplink transmissions and maintaining the connection between the UE and the network.

Although the following description provides examples directed to 5G NR (and, in particular, to message segmentation associated with the UE capability information message), the concepts described herein may be applicable to other similar areas, such as LTE, LTE-A, CDMA, GSM, 6G, and/or other wireless technologies, in which a UE transmits uplink control messages that may be generated with a size that is greater than a packet size limit.

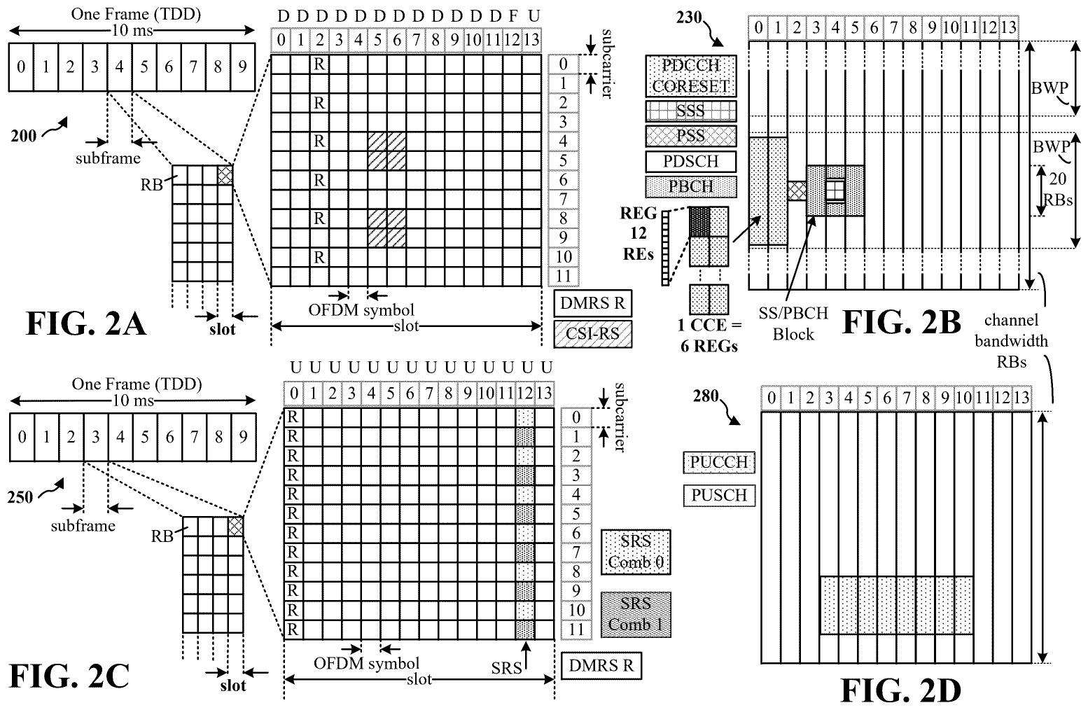

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

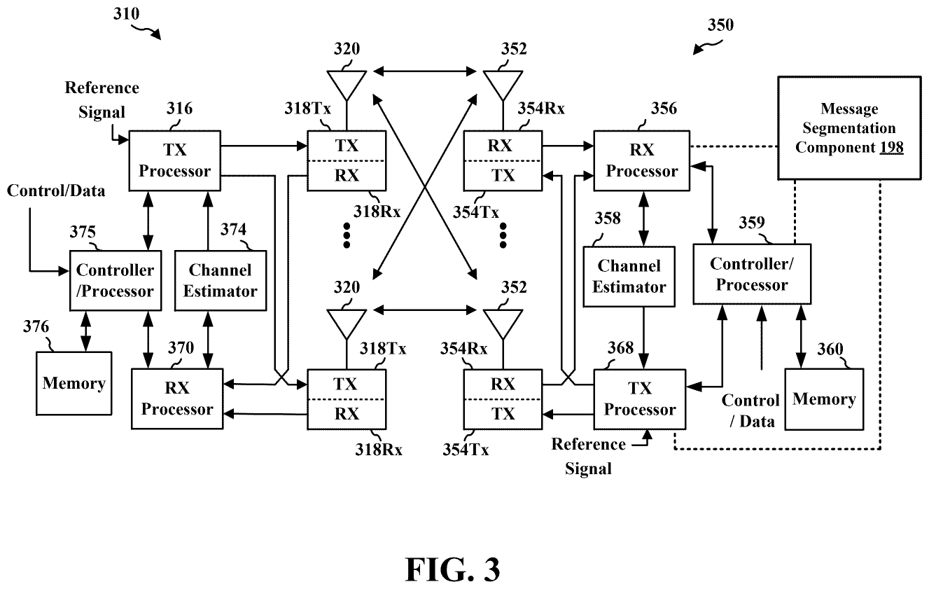

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the message segmentation component 198 of FIG. 1.

In some aspects, wireless communication systems may support the exchange of radio capabilities of a UE in a network, for example, to provide the UE with communication services. In some examples, the network may obtain the radio capabilities of the UE via a UE capability enquiry procedure. For example, a network entity may transmit (e.g., output) a capability enquiry message that is received (e.g., obtained) by the UE. The capability enquiry message may request information indicative of capabilities associated with one or more radio access technologies (RATs) that the UE supports. The UE may then generate a UE capability information message, based on the capability enquiry message, to provide to the network. Examples of UE capability information (e.g., uplink control information) may indicate one or more power classes, one or more frequency bands, one or more carrier aggregation band combinations, one or more duplexing modes, one or more traffic profiles (e.g., voice-centric, data-centric, etc.), one or more radio bearers, etc. supported by the UE. The UE capability information message may be an RRC message. The UE capability information message may be referred to as a “UECapabilityInformation” message or by any other name.

In some aspects, the amount of information for indicating the radio capabilities of the UE may be large, and the size of the uplink control information associated with the UE capability information message (e.g., the UE capability information) may be undesirably large. For example, the size of the UE capability information message may exceed a packet size limit, such as a maximum PDCP SDU size. In such scenarios, to satisfy the packet size limit, the UE may be limited in its ability to express its radio capabilities.

In some aspects, the UE may be configured to employ segmentation to transmit the UE capability information message using segments. For example, the network may provide a segmentation indicator that enables, or disables, message segmentation at the UE for an uplink control message, such as a UE capability information message.

In scenarios in which message segmentation is disabled, the amount of uplink control information that the UE may encode in the uplink control message may be limited so that the size of the uplink control message is not greater than the packet size limit (e.g., the size of the uplink control message is less than or equal to the packet size limit). The UE may then transmit the uplink control message to the network without segmentation.

In scenarios in which message segmentation is enabled, the amount of uplink control information that the UE may encode in the uplink control message may not constrained by the packet size limit for one message. However, the amount of uplink control information encoded in the uplink control message may or may not satisfy the packet size limit. In examples in which the size of the uplink control message fails to satisfy the packet size limit, the UE may perform message segmentation and transmit the uplink control message via two or more segments. For example, the UE may partition the uplink control message into N segments so that a size associated with each respective segment satisfies the packet size limit. Each of the segments may contain a portion of the uplink control message. In some examples, the UE may be configured with a maximum quantity of segments, such as 16 segments. In such scenarios, the amount of uplink control information that the UE may encode into the uplink control message may be limited by the packet size limit and the maximum quantity of segments. The UE may then transmit each of the segments via a segment message to the network. The segment message may be referred to as an “ULDedicatedMessageSegment” message or by any other name.

As an example, the packet size limit in LTE is 8188 bytes. In examples in which the size of the uplink control message is less than or equal to the packet size limit, the UE may transmit the uplink control message without segmentation. In examples in which the size of the uplink control message is greater than the packet size limit, the UE may generate N segments so that each segment contains a portion of the uplink control message and is less than or equal to the packet size limit. For example, the size of the uplink control message encoded by the UE may be 20,000 (20K) bytes. In such examples, the UE may partition the uplink control message into three segments. The three segments may have a same size or may have different sizes. However, the size of any of the three segments is less than or equal to the packet size limit (e.g., less than or equal to the packet size limit of 8188 bytes).

Thus, message segmentation may enable the UE to provide larger amounts of uplink control information. For example, the UE may no longer be constrained by the packet size limit for one packet when encoding an uplink control message.

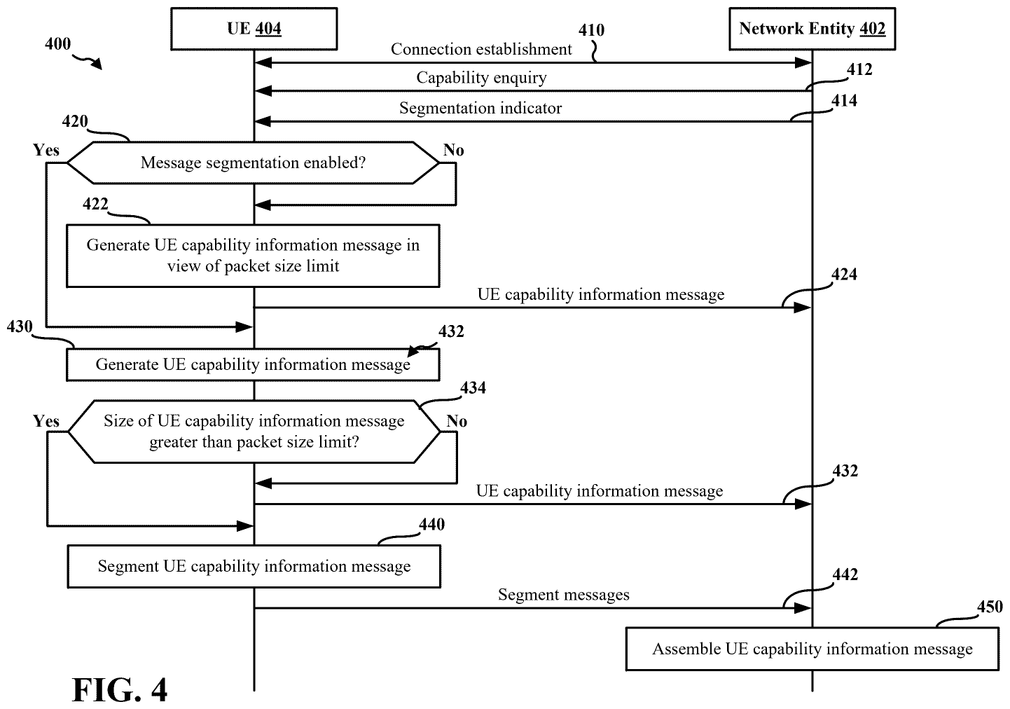

FIG. 4 illustrates an example communication flow 400 between a network entity 402 and a UE 404, as presented herein. One or more aspects described for the network entity 402 may be performed by a component of a base station or a component of a base station, such as a CU, a DU, and/or an RU. Aspects of the network entity 402 be implemented by the base station 102 of FIG. 1 and/or the base station 310 of FIG. 3. Aspects of the UE 404 may be implemented by the UE 104 of FIG. 1 and/or the UE 350 of FIG. 3. Although not shown in the illustrated example of FIG. 4, in additional or alternative examples, the network entity 402 and/or the UE 404 may be in communication with one or more other base stations or UEs.

In the illustrated example of FIG. 4, the communication flow 400 facilitates the UE 404 transmitting an uplink control message that may be obtained by the network entity 402. In some aspects, the UE 404 may transmit the uplink control message without segmentation. In other aspects, the UE 404 may transmit the uplink control message with segmentation.

As shown in FIG. 4, the network entity 402 and the UE 404 are in communication. For example, the UE 404 may perform a connection establishment procedure 410 to establish an RRC connection with the network entity 402. The UE 404 may then communicate with the network entity 402 while operating in an RRC connected mode, which may be referred to as an “RRC_CONNECTED” mode or by any other name.

In the illustrated example of FIG. 4, the network entity 402 may transmit (e.g., output) a capability enquiry message 412 that is received (e.g., obtained) by the UE 404. The capability enquiry message 412 may request radio access capabilities of the UE 404. The radio access capabilities may be associated with one or more RATs, such as NR, E-UTRA, and/or other RATs.

As shown in FIG. 4, the network entity 402 may output a segmentation indicator 414 that is received by the UE 404. The segmentation indicator 414 may indicate whether message segmentation (e.g., RRC message segmentation) is enabled or disabled at the UE 404. For example, the segmentation indicator 414 may be set to a first value (“0”) to indicate that message segmentation is disabled at the UE 404, and may be set to a second value (“1”) to indicate that message segmentation is enabled at the UE 404. In some examples, the segmentation indicator 414 may be included with the capability enquiry message 412. For example, the capability enquiry message 412 may include one or more fields and the segmentation indicator 414 may be provided via at least one field of the capability enquiry message 412. The segmentation indicator 414 may be referred to as an “rrc-SegAllowed” field or by any other name.

As described above, the UE 404 may be configured with message segmentation enabled or disabled. In the illustrated example, the UE 404 may perform a segmentation determination procedure 420 to determine whether the UE 404 is configured to employ message segmentation. If the UE 404 determines that it is not configured to employ message segmentation (e.g., the segmentation indicator 414 is set to a value indicating that message segmentation is disabled), then the UE 404 may perform a generation procedure 422 to generate a UE capability information message 424 with an amount of information (e.g., uplink control information) that satisfies the packet size limit. For example, the amount of uplink control information that the UE 404 may encode in the UE capability information message 424 may be limited so that the size of the UE capability information message 424 is less than or equal to the packet size limit (e.g., the size of the UE capability information message 424 is less than or equal to the maximum PDCP SDU size). The UE capability information message 424 may be an RRC message and may be referred to as an “encoded RRC message,” an “encoded RRC PDU,” or by any other name. The UE 404 may then transmit the UE capability information message 424 without segmentation. That is, the UE 404 may transmit the UE capability information message 424 to the network entity 402 as a non-segmented message.

In scenarios in which the UE 404 determines that message segmentation is enabled (e.g., via the segmentation determination procedure 420), the amount of uplink control information that the UE may encode in an uplink control message is not constrained by the packet size limit for one packet. For example, the UE 404 may perform a generation procedure 430, to generate a UE capability information message 432 in response to the capability enquiry message 412. The amount of uplink control information that the UE 404 may encode in the UE capability information message 432 may not be limited by the packet size limit.

However, the size of the UE capability information message 432 may or may not satisfy the packet size limit. For example, the UE 404 may perform a size determination procedure 434 to determine whether the size of the UE capability information message 432 satisfies the packet size limit.

In examples in which the size of the UE capability information message 432 satisfies the packet size limit (e.g., the UE 404 determines that the size of the UE capability information message 432 is less than or equal to the packet size limit), then the UE 404 may transmit the UE capability information message 432 to the network entity 402 without segmentation. In examples in which the size of the UE capability information message 432 is greater than the packet size limit, the UE 404 may perform message segmentation and transmit the UE capability information message 432 via two or more segments. For example, the UE 404 may perform a segmentation procedure 440 and partition the UE capability information message 432 into N segments. In some examples, the UE 404 may be configured with a maximum quantity of segments, such as 16 segments. In such scenarios, the quantity of the N segments may be less than or equal to the maximum quantity of segments (e.g., N≤16 segments).

As shown in FIG. 4, the UE 404 may transmit segment messages 442 that are received by the network entity 402. A segment message may be referred to as an “ULDedicatedMessageSegment” message or by any other name. The network entity 402 may perform an assembly procedure 450 to re-assemble the UE capability information message 432 based on the segment messages 442 that it receives.

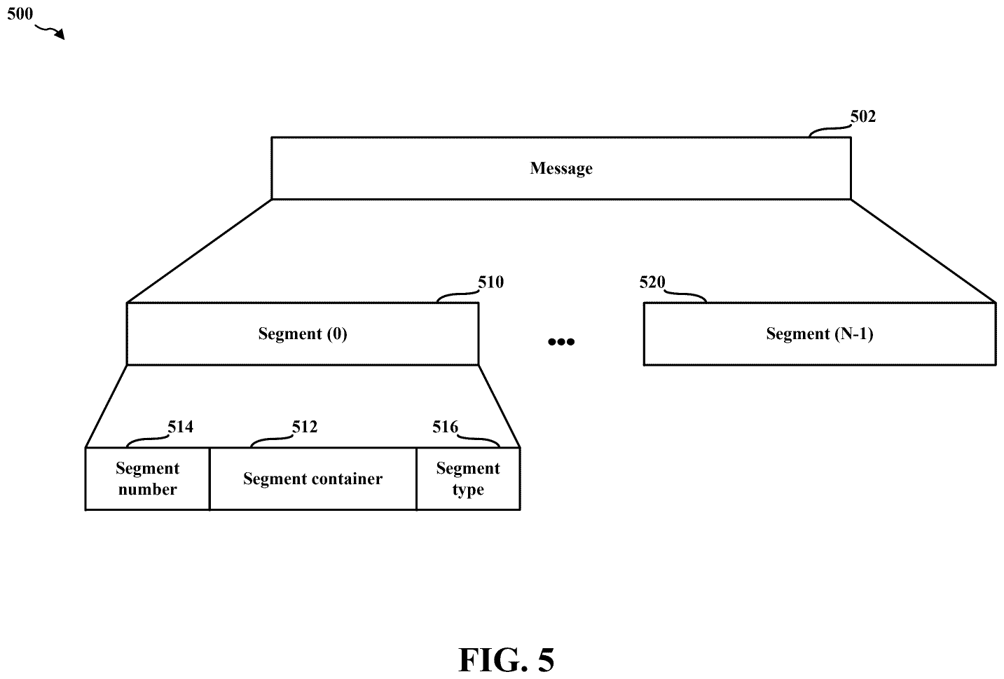

FIG. 5 is a diagram illustrating an example segmentation procedure 500 for an uplink control message 502, as presented herein. Aspects of the uplink control message 502 may be implemented by the UE capability information message 432 of FIG. 4. In the example of FIG. 5, the segmentation procedure 500 may segment the uplink control message 502 into N segments. For example, the segmentation procedure 500 may generate a first segment 510 (“Segment (0)”), . . . , and an n-th segment 520 (“Segment (N−1)”).

Each of the segments may contain a portion of the uplink control message 502. For example, the first segment 510 includes a segment container 512 corresponding to a first portion of the uplink control message 502. The first segment 510 may also include a segment number indicator 514 and a segment type indicator 516. The segment number indicator 514 may indicate a sequence number of the segment based on the N segments. The segment type indicator 516 may indicate whether the respective segment is the last segment of the N segments. For example, the segment type indicator 516 may be set to a first value (“1”) to indicate that the respective segment is the last segment of the N segments, and may be set to a second value (“0”) otherwise.

As an example, the segment number indicator 514 of the first segment 510 may be set to “0” to indicate that it is the first segment of the N segments, and the segment type indicator 516 of the first segment 510 may be set to the second value (“0”) to indicate that it is not the last segment of the N segments. Additionally, the segment number indicator of the n-th segment 520 may be set to “N−1” to indicate that it is the n-th segment of the N segments, and the segment type indicator of the n-th segment 520 may be set to the first value (“1”) to indicate that it is the last segment of the N segments.

Additionally, the size of each respective segment may satisfy the packet size limit. As an example, the size of the uplink control message 502 may be 20K bytes and the UE may be configured with a maximum PDCP SDU size of 9K bytes. In such examples, the UE may partition the uplink control message 502 into three segments each having a size that satisfies the packet size limit (e.g., less than or equal to the maximum PDCP SDU size of 9K bytes). In some examples, the size of each segment message may be the same. For example, the size of each of the three segment messages may be 6,666 bytes (e.g., 20K bytes/3 segments=6,666 bytes/segment). In other examples, the size of the segment messages may be different. For example, the sizes of the first two segment messages may be equal to the packet size limit (e.g., 9K bytes) and the size of the third segment message may be equal to the remaining bytes (e.g., 20K bytes-9K bytes-9K bytes=2K bytes).

Referring again to the example of FIG. 4, it may be appreciated that message segmentation may enable the UE 404 to provide larger amounts of information via an uplink control message. For example, the UE 404 may no longer be constrained by the packet size limit for one packet when encoding the UE capability information message 432.

However, as described above, in some scenarios, employing message segmentation may lead to reduced communication performance. For example, the UE 404 may retransmit one or more of the segment messages 442 if the UE 404 does not receive an ACK message from the network entity 402. In other examples, the network may be unable to handle message segmentation and transmit a connection release message that releases the connection (e.g., the RRC connection) between the network entity 402 and the UE 404. In such scenarios, the UE 404 may stop transmitting the segment messages 442 and the network entity 402 may be unable to determine the radio capabilities of the UE 404.

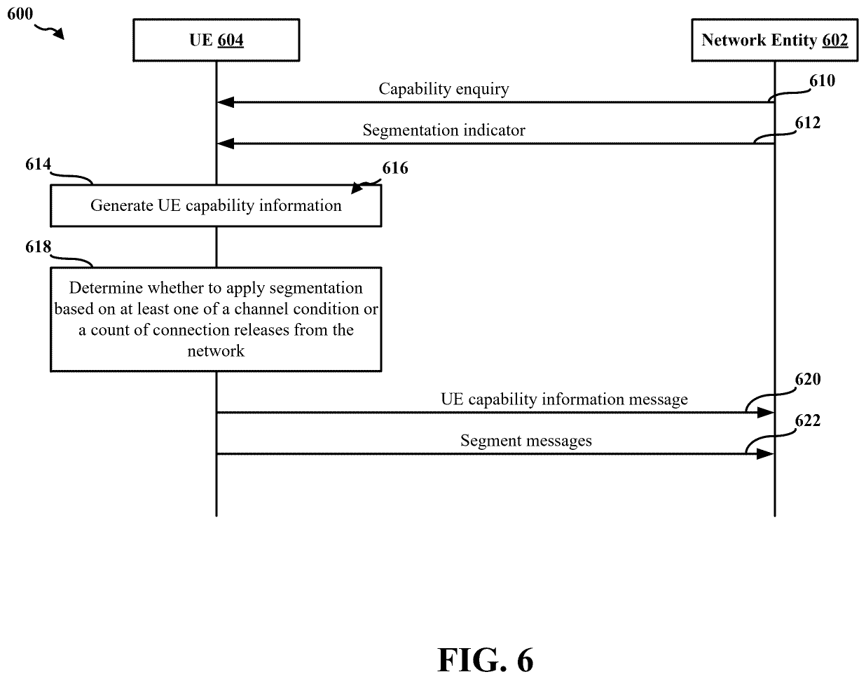

FIG. 6 illustrates an example communication flow 600 between a network entity 602 and a UE 604, as presented herein. One or more aspects described for the network entity 602 may be performed by a component of a base station or a component of a base station, such as a CU, a DU, and/or an RU. Aspects of the network entity 602 be implemented by the base station 102 of FIG. 1 and/or the base station 310 of FIG. 3. Aspects of the UE 604 may be implemented by the UE 104 of FIG. 1 and/or the UE 350 of FIG. 3. Although not shown in the illustrated example of FIG. 6, in additional or alternative examples, the network entity 602 and/or the UE 604 may be in communication with one or more other base stations or UEs.

In the illustrated example of FIG. 6, the communication flow 600 facilitates the UE 604 determining whether to skip applying message segmentation for an uplink control message, even when message segmentation is permitted.

As shown in FIG. 6, the network entity 602 outputs a capability enquiry message 610 that is received by the UE 604. The network entity 602 also outputs a segmentation indicator 612 that is received by the UE 604. The segmentation indicator 612 may indicate whether segmentation is disabled or enabled for an uplink control message associated with the capability enquiry message 610. Aspects of the capability enquiry message 610 may be similar to the capability enquiry message 412 of FIG. 4. Aspects of the segmentation indicator 612 may be similar to the segmentation indicator 414 of FIG. 4.

After receiving the capability enquiry message 610 and the segmentation indicator 612, the UE 604 may perform a generation procedure 614 to generate UE capability information 616 in response to the capability enquiry message 610. The amount of uplink control information that the UE 604 may encode in the UE capability information 616 may not be limited by a packet size limit.

In the illustrated example of FIG. 6, the UE 604 may perform a determination procedure 618 to determine whether to apply segmentation based on at least one of a channel condition or a count of connection releases from the network. The UE 604 may perform the determination procedure 618 even when segmentation is permitted (e.g., the segmentation indicator 612 indicates that segmentation is enabled and a size of the UE capability information 616 is greater than a packet size limit).

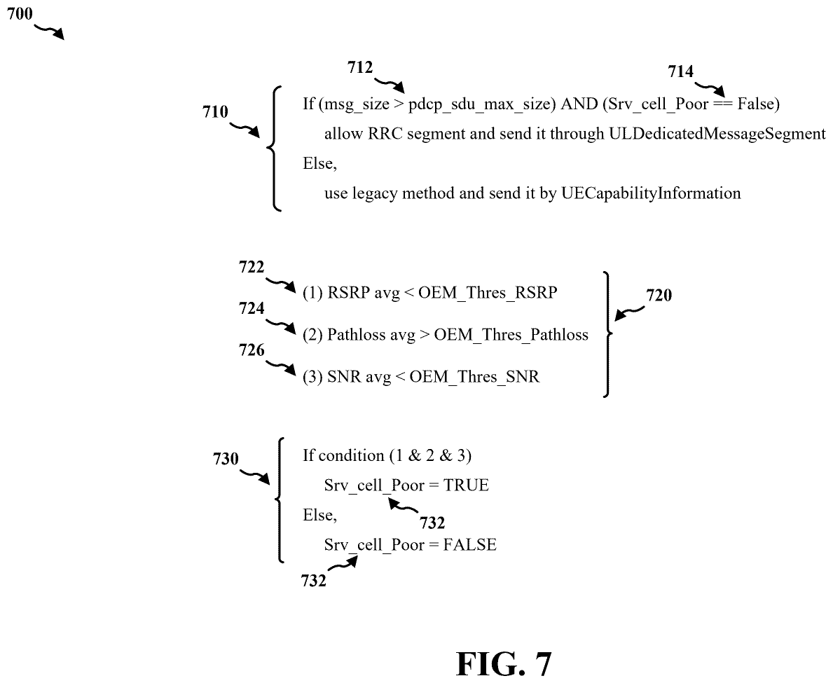

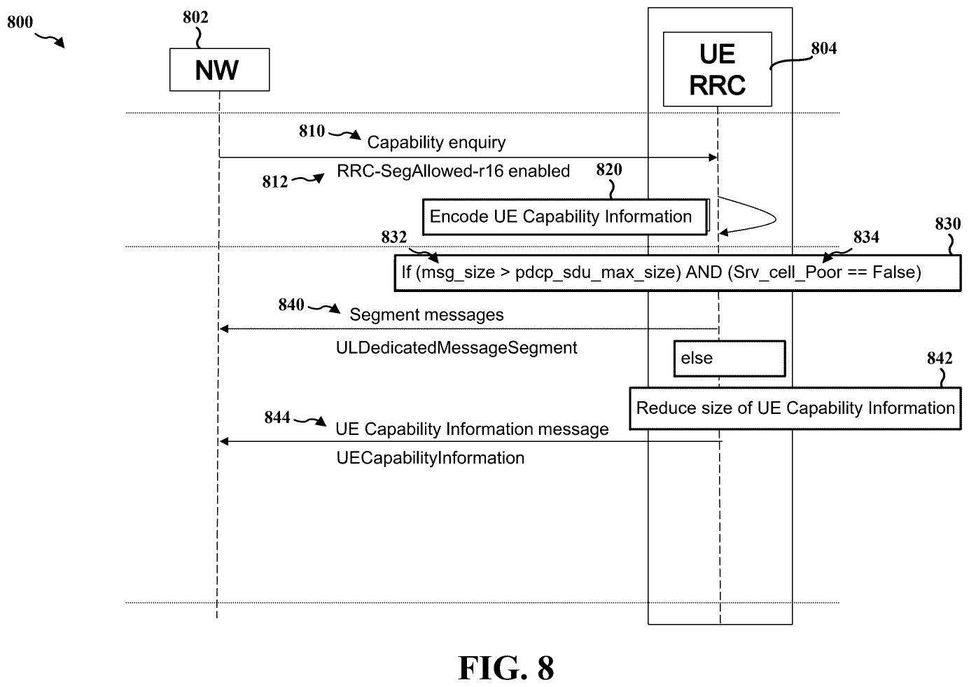

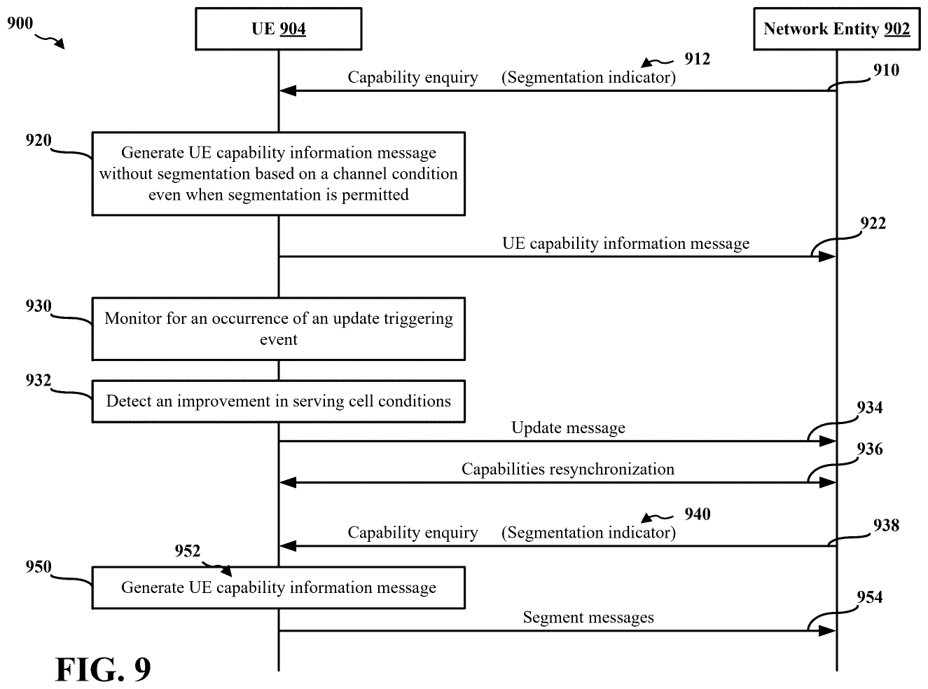

In some examples, the UE 604 may determine to skip applying segmentation based on a channel condition. For example, the UE 604 may determine that the channel conditions are poor and, thus, determine to skip applying segmentation. In some examples, the UE 604 may determine to perform segmentation based on the channel condition. For example, the UE 604 may determine that the channel conditions are not poor. Aspects of determining whether to perform segmentation based on channel conditions are described in connection with the examples of FIG. 7, FIG. 8, and FIG. 9.

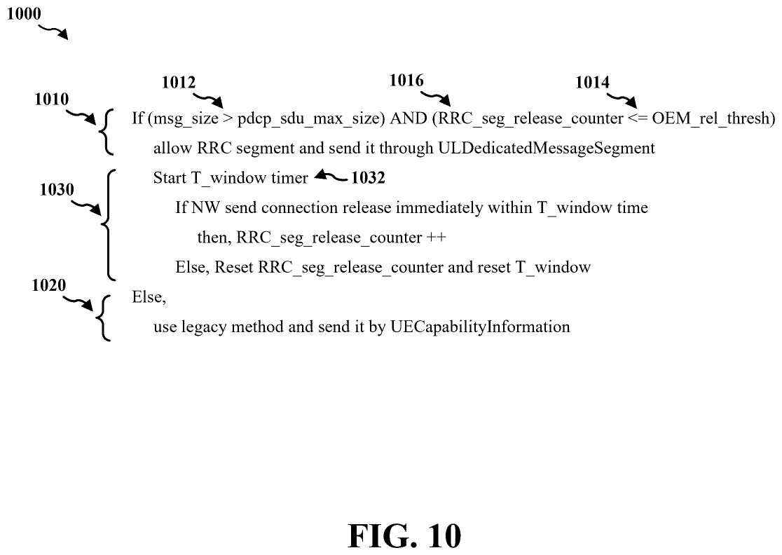

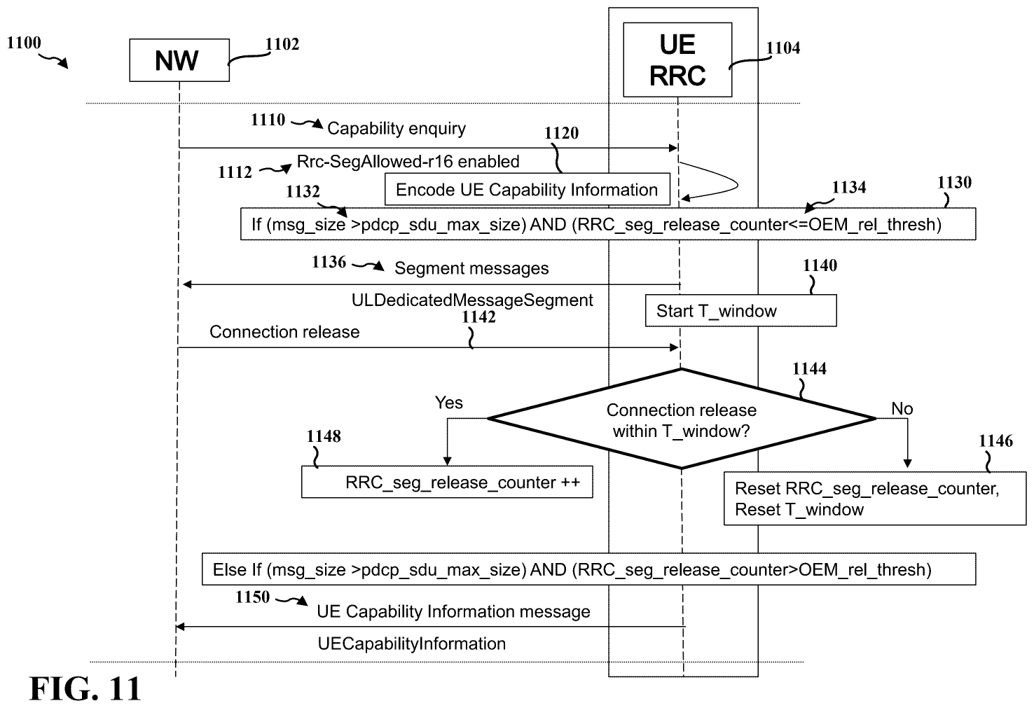

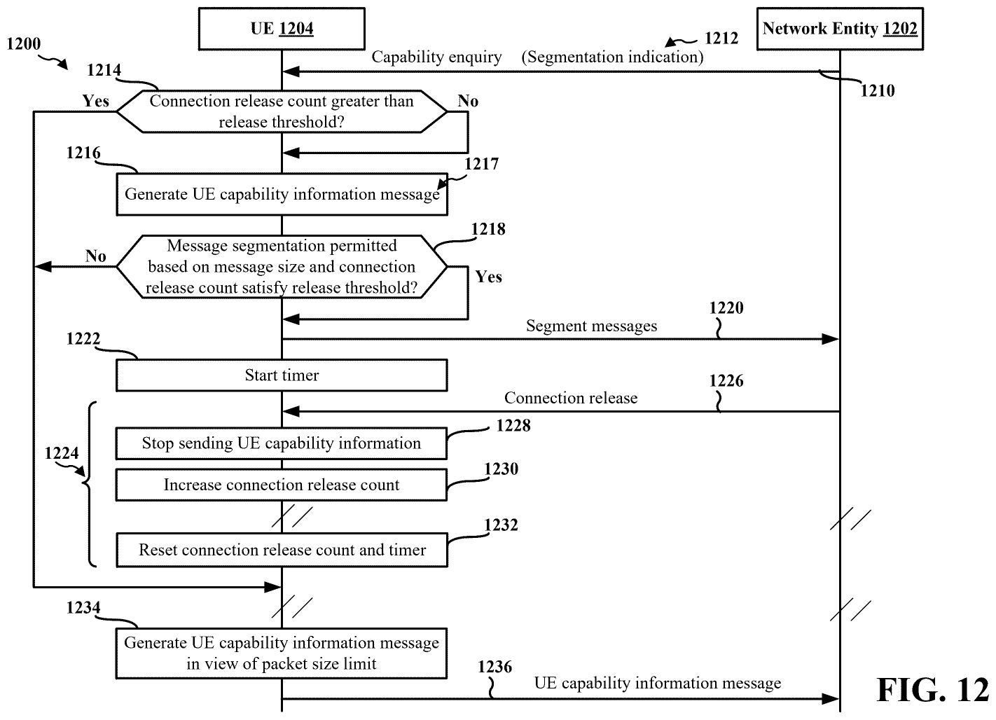

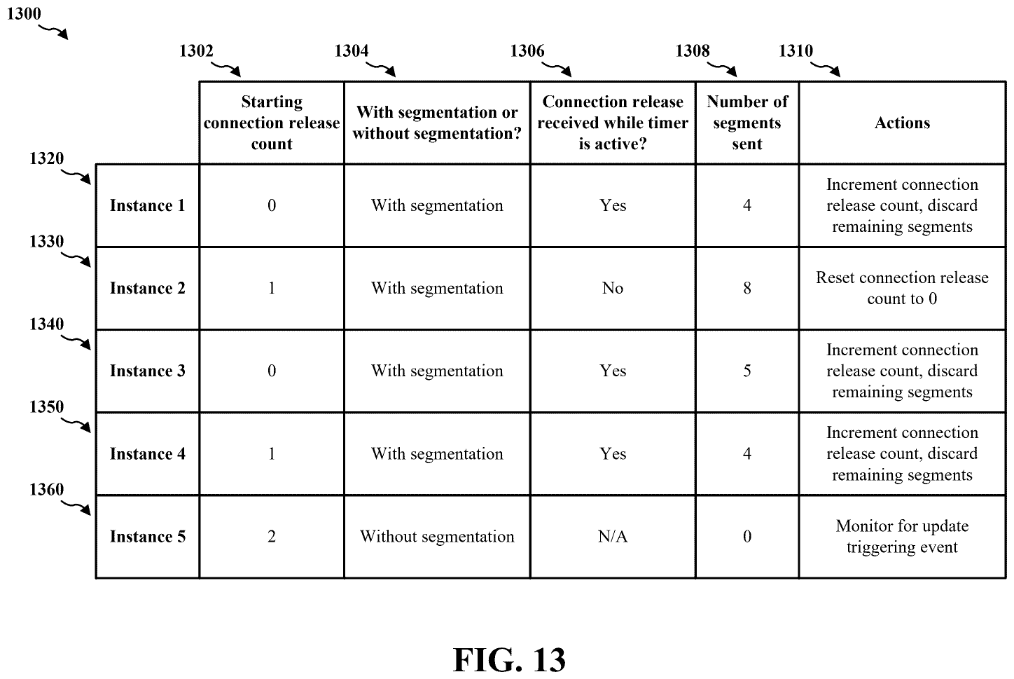

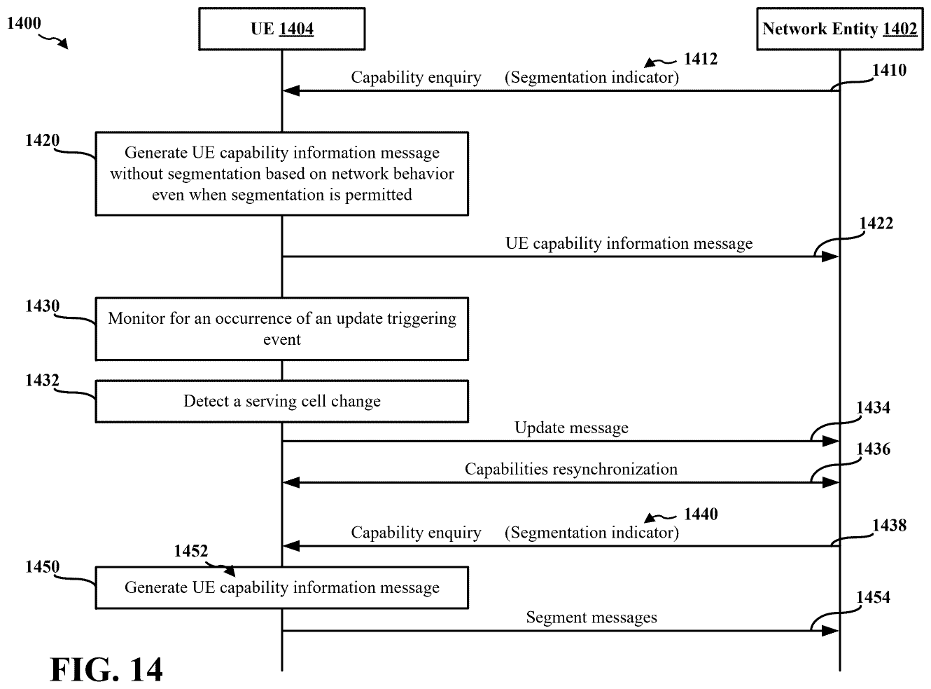

In some examples, the UE 604 may determine to skip applying segmentation (e.g., via the determination procedure 618) based on a count of connection releases from the network. For example, the UE 604 may determine that a count of connection releases maintained by the UE 604 is greater than a threshold and, thus, determine to skip applying segmentation. In other examples, the UE 604 may determine to perform segmentation based on the count of connection releases. For example, the UE 604 may determine that the count of connection releases maintained by the UE 604 is less than or equal to the threshold. Aspects of determining whether to perform segmentation based on a count of connection releases from the network are described in connection with the examples of FIG. 10, FIG. 11, FIG. 12, FIG. 13, and FIG. 14.

In examples in which the UE 604 determines to skip applying segmentation, the UE 604 may transmit a UE capability information message 620 that is obtained by the network entity 602. In some examples, the UE 604 may determine to skip applying segmentation when channel conditions are poor. Additionally, or alternatively, the UE 604 may determine to skip applying segmentation when the count of connection releases is greater than the threshold.

The UE capability information message 620 may be based on the UE capability information 616, but may include a reduced amount of information so that the size of the UE capability information message 620 is less than or equal to the packet size limit. In some examples, the UE 604 may perform a reduction procedure to reduce the size of the UE capability information 616 so that the size of the UE capability information message 620 satisfies the packet size limit.

In examples in which the UE 604 determines to apply segmentation (e.g., via the determination procedure 618), the UE 604 may transmit the UE capability information 616 via two or more segment messages 622 that are obtained by the network entity 602. For example, the UE 604 may determine to apply segmentation when channel conditions are not poor. The UE 604 may additionally, or alternatively, determine to apply segmentation when the count of connection releases from the network is less than or equal to the threshold.

In some examples, the UE may evaluate channel conditions of a serving cell and determine to transmit the uplink control message without segmentation even when message segmentation is permitted. That is, the size of the uplink control message may fail to satisfy the packet size limit (e.g., the size of the uplink control message is greater than the packet size limit), but the UE may determine to transmit the uplink control message without segmentation based on the channel condition. For example, when the UE determines that the channel conditions are poor, the UE may transmit the uplink control message without segmentation. However, when the UE determines that the channel conditions are not poor, then the UE may transmit the uplink control message with segmentation.

In some examples, the UE may determine the channel condition based on measurements associated with a reference signal received power (RSRP), pathloss, and/or a signal-to-noise ratio (SNR). In some examples, the UE may determine that the channel condition is poor when an average RSRP is less than an RSRP threshold. In some examples, the UE may determine that the channel condition is poor when an average pathloss is greater than a pathloss threshold. In some examples, the UE may determine that the channel condition is poor when an average SNR is less than an SNR threshold. In some examples, the UE may determine the channel condition is poor when at least two of the average RSRP, the average pathloss, and the average SNR fail to satisfy their respective thresholds.

In examples in which the UE determines that the channel condition is poor, the UE may determine to transmit the uplink control message without segmentation. For example, the UE may reduce the size of the uplink control message so that it satisfies the packet size limit. In some examples, the UE may re-encode the uplink control message so that the packet size limit is satisfied. For example, the UE may be configured to encode a minimum amount of uplink control information when generating the uplink control message. The minimum amount of uplink control information may correspond to an uplink control message having a size that is less than or equal to the packet size limit.

FIG. 7 includes pseudocode 700 that may facilitate a UE to determine whether to employ message segmentation for an uplink control message based on serving cell conditions, as presented herein. The example pseudocode 700 of FIG. 7 may enable the UE to skip performing message segmentation even when message segmentation is permitted (e.g., based on a size of the uplink control message). In the example of FIG. 7, the pseudocode 700 includes a first pseudocode portion 710 to determine whether to transmit an uplink control message with segmentation or to transmit the uplink control message without segmentation. As shown in FIG. 7, the first pseudocode portion 710 includes a first test 712 to determine whether message segmentation is permitted based on a size of the uplink control message. For example, the UE may compare a size of the uplink control message (“msg_size”) to the packet size limit (“pdcp_sdu_max_size”). If the outcome of the first test 712 is true (e.g., “msg_size>pdcp_sdu_max_size”), then the UE may determine that message segmentation is permitted based on the size of the uplink control message.

The first pseudocode portion 710 includes a second test 714 to determine if the serving cell conditions are poor. The UE may determine the serving cell conditions based on a second pseudocode portion 720 and a third pseudocode portion 730. As shown in the example of FIG. 7, the second pseudocode portion 720 includes three example channel condition tests related to RSRP, pathloss, and SNR. The UE may then determine the serving cell conditions based on the outcomes of the channel condition tests, as illustrated in the third pseudocode portion 730.

For example, in a first channel condition test 722 of the second pseudocode portion 720, the UE compares an average RSRP value to an RSRP threshold (“OEM_Thres_RSRP”). The UE may determine that the outcome of the first channel condition test 722 is true when the average RSRP value is less than the RSRP threshold (“RSRP avg<OEM_Thres_RSRP”). Otherwise, the UE may determine that the outcome of the first channel condition test 722 is false.

In a second channel condition test 724 of the second pseudocode portion 720, the UE compares an average pathloss value to a pathloss threshold (“OEM_Thres_Pathloss”). The UE may determine that the outcome of the second channel condition test 724 is true when the average pathloss value is greater than the pathloss threshold (e.g., Pathloss avg>OEM_Thres_Pathloss”). Otherwise, the UE may determine that the outcome of the second channel condition test 724 is false.

In a third channel condition test 726 of the second pseudocode portion 720, the UE compares an average SNR value to an SNR threshold (“OEM_Thres_SNR”). The UE may determine that the outcome of the third channel condition test 726 is true when the average SNR value is less than the SNR threshold (e.g., “SNR avg<OEM_Thres_SNR”). Otherwise, the UE may determine that the outcome of the third channel condition test 726 is false.

As shown in the third pseudocode portion 730, the UE may set the value of a poor conditions indicator 732 (“Srv_cell_Poor”) based on the outcomes of the respective channel condition tests. In the illustrated example of FIG. 7, the UE may set the value of the poor conditions indicator 732 to a first value (“Srv_cell_Poor=TRUE”) indicating that the serving cell conditions are poor when the outcome of the first channel condition test 722 is true, the outcome of the second channel condition test 724 is true, and the outcome of the third channel condition test 726 is true (e.g., “condition (1 & 2 & 3)”). Otherwise, the UE may set the value of the poor conditions indicator 732 to a second value (“Srv_cell_Poor=FALSE”) indicating that the serving cell conditions are not poor.

Although the example third pseudocode portion 730 of FIG. 7 uses the outcomes of three example channel condition tests to determine the value of the poor conditions indicator 732, in other examples, the number of channel condition tests that the UE applies when setting the value of the poor conditions indicator 732 may be different. Additionally, while the example third pseudocode portion 730 of FIG. 7 indicates that the UE sets the value of the poor conditions indicator 732 to the first value (“TRUE”) when the outcomes of each of the three example channel condition tests are true, in other examples, the UE may set the value of the poor conditions indicator 732 to the first value (“TRUE”) when the outcomes of less than three of the example channel condition tests are true. For example, the UE may set the value of the poor conditions indicator 732 to the first value (“TRUE”) when the outcome of at least one of the three example channel condition tests is true. In other examples, the UE may set the value of the poor conditions indicator 732 to the first value (“TRUE”) when the outcomes of at least two of the three example channel condition tests are true. In some examples, the channel condition tests may be weighted so that if the outcome of a particular channel condition test is true, then the UE may set the value of the poor conditions indicator 732 to the first value (“TRUE”) based on the outcome of the one channel condition test. However, if the outcome of the particular channel condition is false, then the UE may set the value of the poor conditions indicator 732 to the first value (“TRUE”) if the outcomes of the other two channel condition tests are true.

Referring again to the first pseudocode portion 710 of FIG. 7, the UE may apply the second test 714 to determine if the serving cell conditions are not poor. In the example of FIG. 7, the outcome of the second test 714 may be based on the value of the poor conditions indicator 732. For example, the outcome of the second test 714 may be true (e.g., indicating that the serving cell conditions are not poor) when the value of the poor conditions indicator 732 is set to the second value (“FALSE”). That is, in the example of FIG. 7, the outcome of the second test 714 is true when the value of the poor conditions indicator 732 is false (e.g., “Srv_cell_Poor==FALSE”). Otherwise, the UE may determine that the outcome of the second test 714 is false (e.g., indicating that the serving cell conditions are poor) when the value of the poor conditions indicator 732 is set to the first value (“TRUE”).

As shown in the example of FIG. 7, when the outcome of the first test 712 and the second test 714 are each true, then the UE may determine to employ message segmentation (“allow RRC segment”) to the uplink control message and transmit the uplink control message with segment messages, for example, via the “ULDedicatedMessageSegment” messages. Additionally, if the outcome of at least one of the first test 712 and the second test 714 is false, then the UE may determine to transmit the uplink control message without segmentation (e.g., “use legacy method”). For example, the UE may transmit the uplink control message via the “UECapabilityInformation” message. As described above, when the UE determines to transmit an uplink control message without segmentation, then the UE transmits a single message (e.g., the uplink control message) and the size of the uplink control message is configured to satisfy the packet size limit. For example, the UE may encode an amount of uplink control information in the uplink control message so that the size of the uplink control message is less than or equal to the maximum PDCP SDU size.

In the example pseudocode 700 of FIG. 7, the “msg_size” variable represents the encoded size of the uplink control message. The value of the msg_size variable may be represented in bytes and may be determined by the UE after generating the uplink control message. The “pdcp_sdu_max_size” variable represents the maximum allowed size of a PDCP SDU. In some examples, the value of the pdcp_sdu_max_size variable may be known to the UE and/or may be assigned by an administrative body of a standard. For example, the UE may be pre-configured with the value of the pdcp_sdu_max_size variable. In other examples, the value of the pdcp_sdu_max_size variable may be configured and/or activated at the UE by the network, such as via DCI, a MAC-control element (MAC-CE), and/or RRC signaling.

In the second pseudocode portion 720 of FIG. 7, the UE may determine the average RSRP value (“RSRP avg”) based on one or more RSRP measurements. Similarly, the UE may determine the average pathloss value (“Pathloss avg”) based on one or more pathloss measurements and the average SNR value (“SNR avg”) based on one or more SNR measurements.

In the example of FIG. 7, the RSRP threshold (“OEM_Thres_RSRP”), the pathloss threshold (“OEM_Thres_Pathloss”), and the SNR threshold (“OEM_Thres_SNR”) may be used to determine if the outcome of a respective channel condition test is true or false. In some examples, the values of the respective thresholds may be known to the UE. For example, an original equipment manufacturer (OEM) may configure the values of the respective thresholds at the UE. In some examples, the respective value of one or more of the thresholds may be updated. For example, the OEM may provide a firmware update that is applied by the UE. In some such examples, the firmware update may update the respective value of the RSRP threshold, the pathloss threshold, and/or the SNR threshold at the UE.

FIG. 8 illustrates an example communication flow 800 between a network entity 802 and a UE 804, as presented herein. One or more aspects described for the network entity 802 may be performed by a component of a base station or a component of a base station, such as a CU, a DU, and/or an RU. As shown in FIG. 8, the UE 804 is in an RRC connected mode, for example, with the network entity 802. Aspects of the network entity 802 be implemented by the network entity 402 of FIG. 4. Aspects of the UE 804 may be implemented by the UE 404 of FIG. 4. Although not shown in the illustrated example of FIG. 8, in additional or alternative examples, the network entity 802 and/or the UE 804 may be in communication with one or more other base stations or UEs.

In the illustrated example of FIG. 8, the communication flow 800 may facilitate an example implementation of the example pseudocode 700 of FIG. 7. For example, the communication flow 800 may facilitate the UE 804 determining whether to employ message segmentation based on channel conditions of a serving cell (e.g., the network entity 802). For example, the UE 804 may evaluate the signal conditions of the serving cell based on one or more of RSRP, pathloss, and SNR, as described in connection with the second pseudocode portion 720 and the third pseudocode portion 730 of FIG. 7. The UE 804 may then determine whether to employ message segmentation based in part on the serving cell conditions, as described in connection with the first pseudocode portion 710 of FIG. 7.

As shown in FIG. 8, the network entity 802 may transmit a capability enquiry message 810 that is received by the UE 804. The capability enquiry message 810 may include a segmentation indicator 812 (“RRC-SegAllowed-r16 enabled”) indicating that message segmentation is enabled for the uplink control message generated by the UE 804 in response to the capability enquiry message 810. The UE 804 may then generate an uplink control message. For example, the UE 804 may perform an encoding procedure 820 to generate UE capability information based on the capability enquiry message 810.

As shown in FIG. 8, the UE 804 may transmit the UE capability information with segmentation (e.g., via segment messages 840), or may transmit the UE capability information as a single message (e.g., as a UE capability information message 844 without segmentation). For example, the UE 804 may perform a procedure 830 to determine whether to employ message segmentation to the UE capability information. Aspects of the procedure 830 may correspond to the first test 712 and the second test 714 of FIG. 7. For example, the procedure 830 includes two tests. A first test 832 may facilitate determining if message segmentation is permitted based on a size of the UE capability information. For example, the UE 804 may compare a size of the UE capability information to the packet size limit. As described in connection with the first test 712 of FIG. 7, the size of the UE capability information may be represented by a “msg_size” variable and the packet size limit may be presented by a “pdcp_sdu_max_size” variable.

In examples in which the size of the UE capability information is less than or equal to the packet size limit, the UE 804 may determine that the outcome of the first test 832 is false and that message segmentation is not permitted based on the size of the UE capability information. In some such examples, the UE 804 may determine to transmit the UE capability information via a non-segmented message, such as the UE capability information message 844 (e.g., via the “UECapabilityInformation” message).

As shown in FIG. 8, the procedure 830 includes a second test 834. The second test 834 may facilitate determining if serving cell conditions are poor or not poor. In the example of FIG. 8, the outcome of the second test 834 may be based on a value of a poor conditions indicator (“Srv_cell_Poor”). As described in connection with the second test 714 of FIG. 7, the value of the poor conditions indicator may be set based on channel condition tests associated with RSRP (e.g., the first channel condition test 722), pathloss (e.g., the second channel condition test 724), and/or SNR (e.g., the third channel condition test 726).

In examples in which the value of the poor conditions indicator is set to a value indicating that the serving cell conditions are poor (e.g., a value of “TRUE”), the UE 804 may determine that the outcome of the second test 834 is false and determine not to employ message segmentation even if message segmentation is permitted (e.g., the outcome of the first test 832 is true). In some such examples, the UE 804 may determine to transmit the UE capability information via a non-segmented message, such as the UE capability information message 844 (e.g., via the “UECapabilityInformation” message).

Thus, in the example of FIG. 8, the UE 804 may employ message segmentation of the UE capability information when message segmentation is permitted based on the size of the UE capability information (e.g., the outcome of the first test 832 is true) and serving cell conditions are not poor (e.g., the outcome of the second test 834 is true). That is, the example techniques of FIG. 8 may enable the UE 804 to avoid employing message segmentation when serving cell conditions are poor even when message segmentation is permitted based on the size of the UE capability information, which may improve communication performance by reducing overhead associated with uplink transmissions and/or reducing the likelihood of connection drops due to missed downlink signaling, such as an acknowledgement message, from the network entity 802.

In some examples, the UE 804 may determine that message segmentation is permitted based on the size of the UE capability information (e.g., the outcome of the first test 832 is true), but may also determine not to employ message segmentation based on the serving cell conditions being poor (e.g., the outcome of the second test 834 is false). In some such examples, the UE 804 may perform a reduction procedure 842 to reduce the size of the UE capability information so that the size of the UE capability information is less than or equal to the packet size limit. For example, the UE 804 may generate new UE capability information in view of the packet size limit, as described in connection with the generation procedure 422 of FIG. 4.

In some examples, after determining not to employ message segmentation based on the serving cell conditions being poor even when message segmentation is permitted, the UE may continue to skip employing message segmentation until the UE detects an occurrence of an update triggering event. For example, the UE may detect an occurrence of an update triggering event based on an improvement in serving cell conditions. In some examples, the UE may detect the improvement in serving cell conditions based on a change in the outcome of one or more of the channel condition tests of the second pseudocode portion 720 of FIG. 7. In some examples, the UE may detect the improvement in serving cell conditions after performing a mobility procedure to another serving cell.

After detecting the occurrence of the update triggering event, the UE may resynchronize its radio capabilities with the network. For example, the UE may transmit an update message that is received by the network. In some such examples, the update message may cause the network to output another capability enquiry message that is received by the UE and enables the UE to provide its radio capabilities to the network. It may be appreciated that before the UE detects the occurrence of the update triggering event, the amount of uplink control information that the UE may encode in the UE capability information message may be limited by the packet size limit. In such scenarios, to satisfy the packet size limit, the UE may be limited in its ability to express its radio capabilities. However, by resynchronizing its radio capabilities with the network after detecting the improvement in serving cell conditions, the UE may have the ability to provide a larger amount of uplink control information as the UE may no longer be constrained by the packet size limit for one packet when generating the new UE capability information.

FIG. 9 illustrates an example communication flow 900 between a network entity 902 and a UE 904, as presented herein. Aspects of the network entity 902 be implemented by the network entity 402 of FIG. 4 and/or the network entity 802 of FIG. 8. Aspects of the UE 904 may be implemented by the UE 404 of FIG. 4 and/or the UE 804 of FIG. 8. Although not shown in the illustrated example of FIG. 9, in additional or alternative examples, the network entity 902 and/or the UE 904 may be in communication with one or more other base stations or UEs.

In the example of FIG. 9, the UE 904 may be configured to transmit uplink control messages (e.g., a UE capability information message) without segmentation based on determining that serving cell conditions are poor, as described in connection with the second test 834 of FIG. 8 and the transmission of the UE capability information message 844 without segmentation. In the illustrated example of FIG. 9, the communication flow 900 may facilitate the UE 904 performing a capabilities resynchronization with the network entity 902 based on the occurrence of an update triggering event. In some such scenarios, the UE 904 may have the ability to provide a larger amount of uplink control information to the network entity 902 as the UE 904 may no longer be constrained by the packet size limit for one packet when generating a new UE capability information message.

As shown in FIG. 9, the network entity 902 may output a capability enquiry message 910 that is received by the UE 904. The capability enquiry message 910 may include a segmentation indicator 912 indicating that message segmentation is enabled for the uplink control message generated by the UE 904 in response to the capability enquiry message 910. Aspects of the capability enquiry message 910 may be similar to the capability enquiry message 412 and/or the capability enquiry message 810. Aspects of the segmentation indicator 912 may be similar to the segmentation indicator 414 and/or the segmentation indicator 812.

The UE 904 may then generate an uplink control message. For example, the UE 904 may perform a generation procedure 920 to generate a first UE capability information message 922 for transmitting without segmentation. For example, the UE 904 may limit the amount of uplink control information encoded in the first UE capability information message 922 so that a size of the first UE capability information message 922 is less than or equal to a packet size limit. In the illustrated example of FIG. 9, the UE 904 generates the first UE capability information message 922 for transmission without segmentation based on a channel condition (e.g., a poor serving cell condition). The UE 904 may then transmit the first UE capability information message 922 that is received by the network entity 902. The UE 904 may transmit the first UE capability information message 922 without segmentation. For example, the UE 904 may transmit the first UE capability information message 922 via a “UECapabilityInformation” message.

In the illustrated example of FIG. 9, the UE 904 performs a monitoring procedure 930 to monitor for an occurrence of an update triggering event. For example, at 932, the UE 904 may detect an improvement in serving cell conditions. In some examples, the UE 904 may detect the improvement in serving cell conditions based on a change in the outcome of one or more of the channel condition tests included in the second pseudocode portion 720 of FIG. 7. In some examples, the UE 904 may detect the improvement in serving cell conditions after performing a mobility procedure to another serving cell.

As shown in FIG. 9, the UE 904 may transmit an update message 934 that is obtained by the network entity 902. The update message 934 may inform the network entity 902 that the UE 904 wants to resynchronize its capabilities with the network. For example, based on the update message 934, the network entity 902 and the UE 904 may perform a capability resynchronization procedure 936. For example, the network entity 902 may output a capability enquiry message 938 in response to the update message 934. The capability enquiry message 938 may include a segmentation indicator 940 indicating that message segmentation is enabled. Aspects of the capability enquiry message 938 and the segmentation indicator 940 may be similar to the capability enquiry message 910 and the segmentation indicator 912, respectively.

In the illustrated example of FIG. 9, the UE 904 performs a generation procedure 950 to generate a second UE capability information message 952. The UE 904 may generate the second UE capability information message 952 in response to the capability enquiry message 938. The UE 904 may generate the second UE capability information message 952 without being constrained by the packet size limit for one packet. In some such examples, the amount of uplink control information that the UE 904 may encode in the second UE capability information message 952 may be larger than the amount of uplink control information that UE 904 may encode in the first UE capability information message 922. In some scenarios, the UE 904 may be able to provide additional capability information that the UE 904 was previously unable to provide. The UE 904 may then transmit the second UE capability information message 952 via segment messages 954 that are obtained by the network entity 902. Aspects of the segment messages 954 may be similar to the segment messages 442 of FIG. 4 and/or the segment messages 840 of FIG. 8.

As described above, in some aspects, a network may be unable to handle message segmentation and/or may not be configured to receive uplink control messages with segmentation. In some such examples, the network may be configured to transmit a connection release message when it receives an uplink control message (e.g., a UE capability information message) with segmentation. For example, in response to receiving a segment of a UE capability information message, the network may transmit a connection release message. In some aspects, the network may maintain a timer associated with receiving a UE capability information message with segmentation. In some such examples, if the UE takes too long to send the UE capability information message with segmentation, the network may transmit a connection release message. For example, the network may transmit the connection release message if the network has not received all of the segments of the UE capability information message before expiry of the timer. In some such scenarios, the UE may stop sending the remaining segments of the uplink control message after receiving the connection release message. As a result, the UE may be unable to provide the information encoded in the uplink control message to the network. Additionally, the network may be unable to provide certain communication services to the UE based on the network not receiving the information encoded in the uplink control message.

In some aspects, the UE may be configured to determine whether to employ message segmentation, even when message segmentation is permitted, based on an evaluation of the network and its ability to handle message segmentation. In aspects disclosed herein, the UE may maintain a count of connection release messages received from the network when attempting to transmit uplink control messages with segmentation. In some such examples, when the count of connection release messages is greater than a release threshold, the UE may determine to skip using message segmentation even when message segmentation is permitted (e.g., based on the size of the uplink control message).

For example, before generating an uplink control message, the UE may compare its count of connection release messages to the release threshold. In examples in which the count of connection release messages is less than or equal to the release threshold, the UE may generate the uplink control message without being constrained by the packet size limit for one packet. The UE may then transmit the uplink control message with or without segmentation based on the size of the uplink control message. In examples in which the count of connection release messages is greater than the release threshold, the UE may then generate the uplink control message by limiting the amount of uplink control information encoded in the uplink control message based on size of the uplink control message.

In some examples, the UE may increase the count of connection release messages when the UE receives a connection release message immediately after transmitting an uplink control message with segmentation. For example, the UE may initiate a timer when transmitting a segment message (e.g., a segment of the uplink control message) and maintain the timer until transmission of the uplink control message with segmentation is complete or a connection release message is received. In examples in which the UE receives a connection release message while the timer is active, the UE may increment the count of connection release messages. In some examples, the UE may reset the count of connection release messages when the UE is able to transmit the uplink control message with segmentation without receiving a connection release message from the network. In other examples, if the UE receives a connection release message while the timer is inactive (e.g., while not attempting to transmit a segment message), the UE may determine that the network transmitting the connection release message was unrelated to the ability of the network to handle message segmentation. In such examples, the UE may skip incrementing the count of connection release messages.

In some examples, if the UE completes transmitting an uplink control message with segmentation before receiving a connection release message, the UE may determine that the network is able to receive uplink control messages with segmentation and, thus, continue using message segmentation when permitted (e.g., when message segmentation is enabled and the size of the UE capability information message fails to satisfy the packet size limit).

FIG. 10 includes pseudocode 1000 that may facilitate a UE to determine whether to employ message segmentation for an uplink control message based on network behavior causing the network to output immediate connection release messages, as presented herein. The example pseudocode 1000 of FIG. 10 may enable the UE to evaluate network behavior and the ability of the network to support uplink control messages with segmentation. For example, the network may be configured to transmit a connection release message when it receives a segment message or when a timer associated with receiving an uplink control message with segmentation expires.

In the example of FIG. 10, the pseudocode 1000 includes a first pseudocode portion 1010 and a second pseudocode portion 1020 that enable the UE to transmit an uplink control message with segmentation or to transmit the uplink control message without segmentation. For example, the first pseudocode portion 1010 includes a first test 1012 to determine whether message segmentation is permitted based on a size of the uplink control message. For example, the UE may compare a size of the uplink control message (“msg_size”) to the packet size limit (“pdcp_sdu_max_size”). If the outcome of the first test 1012 is true (e.g., “msg_size>pdcp_sdu_max_size”), then the UE may determine that message segmentation is permitted based on the size of the uplink control message. Otherwise, the UE may determine that the outcome of the first test 1012 is false. Aspects of the first test 1012 may be similar to the first test 712 of FIG. 7.

As shown in FIG. 10, the first pseudocode portion 1010 includes a second test 1014 to determine if a count of connection release messages satisfies a release threshold (“OEM_rel_thresh”). For example, the UE may maintain a connection release counter 1016 (“RRC_seg_release_counter”) that indicates a count of connection release messages that the UE receives when attempting to transmit uplink control messages with segmentation. In the example of FIG. 10, the UE may determine that the output of the second test 1014 is true when the value of the connection release counter 1016 is less than or equal to the release threshold (“RRC_seg_release_counter<=OEM_rel_thresh”). Otherwise, the UE may determine that the output of the second test 1014 is false (e.g., when the value of the connection release counter 1016 is greater than the release threshold).

In the example of FIG. 10, the release threshold (“OEM_rel_thresh”) is a parameter with a value to ensure that the UE observes immediate connection releases from the network a minimum number of times. In some examples, the value of the release threshold may be known to the UE. For example, an OEM may configure the value of the release threshold at the UE. In some examples, the value of release threshold may be updated. For example, the OEM may provide a firmware update that is applied by the UE. In some such examples, the firmware update may update the value of the release threshold.

In the illustrated example of FIG. 10, if the output of at least one of the first test 1012 and the second test 1014 is false, then the UE may determine to transmit the uplink control message without segmentation (e.g., “use legacy method”), as indicated by the second pseudocode portion 1020. For example, the UE may transmit the uplink control message via the “UECapabilityInformation” message. As described above, when the UE determines to transmit an uplink control message without segmentation, then the UE transmits a single message (e.g., the uplink control message) and the size of the uplink control message is configured to satisfy the packet size limit. For example, the UE may encode an amount of uplink control information in the uplink control message so that the size of the uplink control message is less than or equal to the maximum PDCP SDU size.

Referring again to the example first pseudocode portion 1010, if the outputs of the first test 1012 and the second test 1014 are both true, then the UE may determine to employ message segmentation (“allow RRC segment”) to the uplink control message and transmit the uplink control message with segment messages, for example, via the “ULDedicatedMessageSegment” messages.

In the example of FIG. 10, after transmitting a segment message (“send it through ULDedicatedMessageSegment”), the UE may perform a third pseudocode portion 1030 configured to manage the count of the connection release counter 1016. For example, the UE may start a timer 1032 (“T_window”). The timer 1032 may be set to value to enable the UE to determine if a connection release message is immediate or not. That is, if the UE receives a connection release message while the timer 1032 is active, then the UE may determine that the connection release message is “immediate.” Otherwise, the UE may determine that the connection release message is not immediate.

In some examples, the duration of the timer 1032 may be known to the UE and/or may be assigned by an administrative body of a standard. For example, the UE may be pre-configured with the duration of the timer 1032. In other examples, the duration of the timer 1032 may be configured and/or activated at the UE by the network, such as via DCI, a MAC-CE, and/or RRC signaling.

As shown in FIG. 10, if the UE receives a connection release message while the timer 1032 is active (“NW send connection release immediately within T_window time”), then the UE increments the value of the connection release counter 1016 (“RRC_seg_release_counter++”). However, if the UE does not receive a connection release while the timer 1032 is active and, thus, the UE successfully transmitted the uplink control message with segmentation, the UE may reset the count of connection releases from the network (“Reset “RRC_seg_release_counter”). The UE may also reset the timer 1032 (“reset T_window”).

FIG. 11 illustrates an example communication flow 1100 between a network entity 1102 and a UE 1104, as presented herein. One or more aspects described for the network entity 1102 may be performed by a component of a base station or a component of a base station, such as a CU, a DU, and/or an RU. As shown in FIG. 11, the UE 1104 is in an RRC connected mode, for example, with the network entity 1102. Aspects of the network entity 1102 be implemented by the network entity 402 of FIG. 4. Aspects of the UE 1104 may be implemented by the UE 404 of FIG. 4. Although not shown in the illustrated example of FIG. 11, in additional or alternative examples, the network entity 1102 and/or the UE 1104 may be in communication with one or more other base stations or UEs.

In the illustrated example of FIG. 11, the communication flow 1100 may facilitate an example implementation of the example pseudocode 1000 of FIG. 10. For example, the communication flow 1100 may facilitate the UE 1104 determining whether to employ message segmentation based on network behavior. For example, the UE 1104 may maintain a count of connection release messages received in response to an uplink control message with segmentation, as described in connection with the third pseudocode portion 1030 of FIG. 10. The UE may then determine whether to employ message segmentation based in part on count of connection release messages, as described in connection with the first pseudocode portion 1010 of FIG. 10.

As shown in FIG. 11, the network entity 1102 may transmit a capability enquiry message 1110 that is received by the UE 1104. The capability enquiry message 1110 may include a segmentation indicator 1112 (“RRC-SegAllowed-r16 enabled”) indicating that message segmentation is enabled for the uplink control message generated by the UE 1104 in response to the capability enquiry message 1110. The UE 1104 may then generate an uplink control message. For example, the UE 1104 may perform an encoding procedure 1120 to generate UE capability information based on the capability enquiry message 1110.

As shown in FIG. 11, the UE 1104 may transmit the UE capability information with segmentation (e.g., via segment messages 1136), or may transmit the UE capability information as a single message (e.g., as a UE capability information message 1150 without segmentation). For example, the UE 1104 may perform a procedure 1130 to determine whether to employ message segmentation to the UE capability information. Aspects of the procedure 1130 may correspond to the first test 1012 and the second test 1014 of FIG. 10. For example, the procedure 1130 includes two tests. A first test 1132 may facilitate determining if message segmentation is permitted based on a size of the UE capability information. For example, the UE 1104 may compare a size of the UE capability information to the packet size limit. As described in connection with the first test 1012 of FIG. 10, the size of the UE capability information may be represented by a “msg_size” variable and the packet size limit may be presented by a “pdcp_sdu_max_size” variable.

In examples in which the size of the UE capability information is less than or equal to the packet size limit, the UE 1104 may determine that the outcome of the first test 1132 is false and that message segmentation is not permitted based on the size of the UE capability information. In some such examples, the UE 1104 may determine to transmit the UE capability information via a non-segmented message, such as the UE capability information message 1150 (e.g., via the “UECapabilityInformation” message).

As shown in FIG. 11, the procedure 1130 includes a second test 1134. The second test 1134 may facilitate determining if a threshold quantity of connection release messages have been released. For example, the value of the release threshold (“OEM_rel_thresh”) may be configured so that the UE receives immediate connection release messages from the network multiple times. As described in connection with the second test 1014 of FIG. 10, the outcome of the second test 1134 may be true when the connection release counter (“RRC_seg_release_counter”) is less than or equal to the release threshold (“RRC_seg_release_counter<=OEM_rel_thresh”).

In examples in which the value of the connection release counter is greater than the release threshold, the UE 1104 may determine that the outcome of the second test 1134 is false and determine not to employ message segmentation even if message segmentation is permitted (e.g., the outcome of the first test 1132 is true). In some such examples, the UE 1104 may determine to transmit the UE capability information via a non-segmented message, such as the UE capability information message 1150 (e.g., via the “UECapability Information” message).

In the illustrated example of FIG. 11, if the outcomes of the first test 1132 and the second test 1134 are both true, then the UE may proceed with sending the UE capability information with segmentation via the segment messages 1136 (“ULDedicatedMessageSegment”). As shown in FIG. 11, after transmitting a segment message, the UE 1104 may initiate a timer 1140. The duration of the timer 1140 may be configured to enable the UE 1104 to determine whether a connection release message is in response to the segment message (e.g., an “immediate” connection release message).

The UE 1104 may then monitor for a connection release message from the network (e.g., the network entity 1102). For example, the UE 1104 may perform a procedure 1144 to determine whether a connection release message is received while the timer 1140 is active. If the UE 1104 determines that a connection release message was not received while the timer 1140 is active, then the UE 1104 may perform a reset procedure 1146 and reset the value of the connection release counter and reset the timer 1140, as described in connection with third pseudocode portion 1030 of FIG. 10. If the UE 1104 determines that a connection release message was received while the timer 1140 is active, then the UE 1104 may perform an increment procedure 1148 to increment the connection release counter (“RRC_seg_release_counter++”). For example, the network entity 1102 may output a connection release message 1142 that is received by the UE 1104. If the UE 1104 receives the connection release message 1142 while the timer 1140 is active, then the UE 1104 performs the increment procedure 1148 and increments the connection release counter, for example, by one.

Thus, in the example of FIG. 11, the UE 1104 may employ message segmentation of the UE capability information when message segmentation is permitted based on the size of the UE capability information (e.g., the outcome of the first test 1132 is true) and an evaluation of network behavior (e.g., the outcome of the second test 1134 is true). That is, the example techniques of FIG. 11 may enable the UE 1104 to avoid employing message segmentation when network behavior indicates that the network is unable to handle and/or not configured to receive uplink control messages with segmentation. In examples in which the UE avoids message segmentation based on a count of connection release messages, the UE may be able to improve communication performance by maintaining a connection with the network. For example, if the network is performing immediate connection releases after the UE transmits a segment message, the UE may have the ability to determine, based on the count of connection release messages, that the network is unable to handle message segmentation. In such examples, the UE may skip message segmentation when communicating with the network to maintain the connection with the network.

FIG. 12 illustrates an example communication flow 1200 between a network entity 1202 and a UE 1204, as presented herein. Aspects of the network entity 1202 be implemented by the network entity 402 of FIG. 4 and/or the network entity 1102 of FIG. 11. Aspects of the UE 1204 may be implemented by the UE 404 of FIG. 4 and/or the UE 1104 of FIG. 11. Although not shown in the illustrated example of FIG. 12, in additional or alternative examples, the network entity 1202 and/or the UE 1204 may be in communication with one or more other base stations or UEs.

In the example of FIG. 12, the UE 1204 may be configured to transmit uplink control messages (e.g., a UE capability information message) without segmentation based on network behavior, as described in connection with the second test 1134 of FIG. 11 and the transmission of the UE capability information message 1150 without segmentation.

As shown in FIG. 12, the network entity 1202 may output a capability enquiry message 1210 that is received by the UE 1204. The capability enquiry message 1210 may include a segmentation indicator 1212 indicating that message segmentation is enabled for the uplink control message generated by the UE 1204 in response to the capability enquiry message 1210. Aspects of the capability enquiry message 1210 may be similar to the capability enquiry message 412 and/or the capability enquiry message 1110. Aspects of the segmentation indicator 1212 may be similar to the segmentation indicator 414 and/or the segmentation indicator 1112.

The UE may then perform a procedure 1214 to determine whether the connection release counter satisfies the release threshold, as described in connection with the second test 1134 of FIG. 11. If the value of the connection release counter is greater than the release threshold (e.g., “RRC_seg_release_counter>OEM_rel_thresh”), then the UE 1204 may generate an uplink control message. For example, the UE 1204 may perform a generation procedure 1234 to generate a UE capability information message 1236 for transmitting without segmentation. For example, the UE 1204 may limit the amount of uplink control information encoded in the UE capability information message 1236 so that a size of the UE capability information message 1236 is less than or equal to a packet size limit. The UE 1204 may then transmit the UE capability information message 1236 that is received by the network entity 1202. The UE 1204 may transmit the UE capability information message 1236 without segmentation. For example, the UE 1204 may transmit the UE capability information message 1236 via a “UECapabilityInformation” message.

Returning to the procedure 1214, if the UE 1204 determines that the connection release count is not greater than the release threshold (e.g., “RRC_seg_release_counter<=OEM_rel_thresh”), then the UE 1204 may perform a generation procedure 1216 to generate a UE capability information message 1217. The UE 1204 may generate the UE capability information message 1217 without being constrained by the packet size limit for one packet. In some such examples, the amount of uplink control information that the UE 1204 may encode in the UE capability information message 1217 may be larger than the amount of uplink control information that UE 1204 may encode in the UE capability information message 1236.

After generating the UE capability information message, the UE 1204 may perform a procedure 1218 to determine if message segmentation is permitted and the connection release count satisfies the release threshold, as described in connection with the procedure 1130 of FIG. 11. If the UE 1104 determines that one of the tests if false, then the UE 1104 perform the generation procedure 1234 to generate a new UE capability information message in view of the packet size limit. The UE 1104 may then transmit the new UE capability information message that is received by the network entity 1202.

Returning to the procedure 1218, if the UE 1204 determines that both tests are true, as described in connection with the procedure 1130 of FIG. 11, then UE 1204 may transmit the UE capability information message 1217 with segmentation. For example, the UE 1204 may transmit segment messages 1220 that are received by the network entity 1202. Aspects of the segment messages 1220 may be similar to the segment messages 442 of FIG. 4 and/or the segment messages 1136 of FIG. 11.

As shown in FIG. 12, after the UE 1204 transmits the segment messages 1220, the UE 1204 may start a timer 1222. Aspects of the timer 1222 may be similar to the timer 1140 of FIG. 11. The UE 1204 may also initiate a monitoring procedure 1224 to monitor for connection release messages from the network while the timer 1222 is active. For example, the network entity 1202 may output a connection release message 1226 that is received by the UE 1204 while the timer 1222 is active. In such scenarios, the UE 1204 may perform a stopping procedure 1228 to stop sending any remaining segments of the UE capability information message 1217. The UE 1204 may also perform an increment procedure 1230 to increase the connection release count, as described in connection with the increment procedure 1148 of FIG. 11. The UE 1204 may then monitor for another capability enquiry message from the network entity 1202.

In examples in which the UE 1204 does not receive a connection release message from the network entity 1202 while performing the monitoring procedure 1224 (e.g., while the timer 1222 is active), the UE 1204 may perform a reset procedure 1232. For example, the UE 1204 may perform the reset procedure 1232 if the UE 1204 successfully transmits the UE capability information message 1217 with segmentation without receiving a connection release message while the timer 1222 is active. The UE 1204 may perform the reset procedure 1232 to reset the connection release count and the timer 1222, as described in connection with the reset procedure 1146 of FIG. 11. The UE 1204 may then monitor for another capability enquiry message from the network entity 1202.

FIG. 13 depicts a table 1300 illustrating different actions taken by a UE with respect to different instances of capability enquiry messages, as presented herein. In the example of FIG. 13, the UE may be configured with a release threshold of one (1). Thus, the UE may continue to attempt to transmit uplink control messages with segmentation until the connection release counter reaches two (2). In the example of FIG. 13, the UE capability information has a large enough size that the UE partitions the UE capability information into eight (8) segments.

As shown in FIG. 13, the UE receives five instances of a capability enquiry message, such as the capability enquiry message 1210 of FIG. 12. The example table 1300 includes a first column 1302 indicating the count of connection releases (e.g., the value of the connection release counter), a second column 1304 indicating whether the UE employs segmentation or no segmentation, a third column 1306 that indicates whether a connection release message was received while a timer (e.g., the timer 1222 of FIG. 12) is active, a fourth column 1308 that indicates a quantity of segments that were transmitted before the connection release message was received (if any), and a fifth column 1310 indicating what actions the UE performs based on the information indicated by the third column 1306 and the fourth column 1308.

In the illustrated example of FIG. 13, for a first instance 1320 (“Instance 1”) of a capability enquiry message, the UE determines that the value of the connection release counter is zero (0) and less than or equal to the release threshold (1). Accordingly, the UE may proceed to transmit the UE capability information with segmentation, as shown in the second column 1304. With respect to the first instance 1320, the “Yes” in the third column 1306 indicates that the UE receives a connection release message from the network while the timer is active and the entry in the fourth column 1308 indicates that the UE transmitted four of the eight segments of the UE capability information. As shown in the fifth column 1310 of the first instance 1320, the UE increments the connection release count from “0” to “1” (e.g., as described in connection with the increment procedure 1230 of FIG. 12). The UE also stops sending the remaining segments (e.g., the remaining four segments) of the UE capability information.

In the illustrated example of FIG. 13, for a second instance 1330 (“Instance 2”) of a capability enquiry message, the UE determines that the value of the connection release counter is one (1) and less than or equal to the release threshold (1). Accordingly, the UE may proceed to transmit the UE capability information with segmentation, as shown in the second column 1304. With respect to the second instance 1330, the “No” in the third column 1306 indicates that the UE did not receive a connection release message from the network while the timer is active. Accordingly, the UE may successfully complete the transmission of the UE capability information with segmentation (e.g., the UE transmits all eight (8) segments of the UE capability information). As shown in the fifth column 1310 of the second instance 1330, the UE resets the connection release count from “1” to “0” (e.g., as described in connection with the reset procedure 1232 of FIG. 12).

In the illustrated example of FIG. 13, for a third instance 1340 (“Instance 3”) of a capability enquiry message, the UE determines that the value of the connection release counter is zero (0) and less than or equal to the release threshold (1). Accordingly, the UE may proceed to transmit the UE capability information with segmentation, as shown in the second column 1304. With respect to the third instance 1340, the “Yes” in the third column 1306 indicates that the UE receives a connection release message from the network while the timer is active and the entry in the fourth column 1308 indicates that the UE transmitted five of the eight segments of the UE capability information. As shown in the fifth column 1310 of the third instance 1340, the UE increments the connection release count from “0” to “1” (e.g., as described in connection with the increment procedure 1230 of FIG. 12). The UE also stops sending the remaining segments (e.g., the remaining three segments) of the UE capability information.

In the illustrated example of FIG. 13, for a fourth instance 1350 (“Instance 5”) of a capability enquiry message, the UE determines that the value of the connection release counter is one (1) and less than or equal to the release threshold (1). Accordingly, the UE may proceed to transmit the UE capability information with segmentation, as shown in the second column 1304. With respect to the fourth instance 1350, the “Yes” in the third column 1306 indicates that the UE receives a connection release message from the network while the timer is active and the entry in the fourth column 1308 indicates that the UE transmitted four of the eight segments of the UE capability information. As shown in the fifth column 1310 of the first instance 1320, the UE increments the connection release count from “1” to “2” (e.g., as described in connection with increment procedure 1230 of FIG. 12). The UE also stops sending the remaining segments (e.g., the remaining four segments) of the UE capability information.

In the illustrated example of FIG. 13, for a fifth instance 1360 (“Instance 5”) of a capability enquiry message, the UE determines that the value of the connection release counter is two (2) and greater than the release threshold (1). Accordingly, the UE may determine to transmit the UE capability information without segmentation, as described in connection with generation procedure 1234 and the UE capability information message 1236 of FIG. 12. As the UE is transmitting the UE capability information without segmentation, the UE may skip initiating a timer for determining if the UE receives a connection release message in response to a segment message. Additionally, as the UE is transmitting the UE capability information without segmentation, there are no segments sent, as shown in the entry of the fourth column 1308 for the fifth instance 1360.

In the example of FIG. 13, after the UE determines to transmit uplink control messages (e.g., the UE capability information) without segmentation based on the connection release counter, the UE may continue to transmit subsequent uplink control messages without segmentation. For example, for a sixth instance of a capability enquiry message, the value of the connection release counter remains at two (2), which is greater than the release threshold (1).

As shown in FIG. 13, after the UE determines to transmit uplink control messages without segmentation based on the connection release counter, the UE may perform a monitoring procedure to monitor for an occurrence of an update triggering event. In examples in which the UE determines to skip employing message segmentation based on the count of connection release messages, the UE may detect the occurrence of an update triggering event based on a change in its connection with the network. For example, the UE may detect the occurrence of the update triggering event in response to a change in at least one of a serving cell, a tracking area, or a serving network node. In some examples, the UE may determine a change in the tracking area based on a change in a TAI and/or a change in an RA.

FIG. 14 illustrates an example communication flow 1400 between a network entity 1402 and a UE 1404, as presented herein. Aspects of the network entity 1402 be implemented by the network entity 402 of FIG. 4 and/or the network entity 1102 of FIG. 11. Aspects of the UE 1404 may be implemented by the UE 404 of FIG. 4 and/or the UE 1104 of FIG. 11. Although not shown in the illustrated example of FIG. 14, in additional or alternative examples, the network entity 1402 and/or the UE 1404 may be in communication with one or more other base stations or UEs.

In the example of FIG. 14, the UE 1404 may be configured to transmit uplink control messages (e.g., a UE capability information message) without segmentation based on an evaluation of network behavior, as described in connection with the second test 1134 of FIG. 11 and the transmission of the UE capability information message 1150 without segmentation. In the illustrated example of FIG. 14, the communication flow 1400 may facilitate the UE 1404 performing a capabilities resynchronization with the network entity 1402 based on the occurrence of an update triggering event. In some such scenarios, the UE 1404 may have the ability to provide a larger amount of uplink control information to the network entity 1402 as the UE 1404 may no longer be constrained by the packet size limit for one packet when generating a new UE capability information message.

As shown in FIG. 14, the network entity 1402 may output a capability enquiry message 1410 that is received by the UE 1404. The capability enquiry message 1410 may include a segmentation indicator 1412 indicating that message segmentation is enabled for the uplink control message generated by the UE 1404 in response to the capability enquiry message 1410. Aspects of the capability enquiry message 1410 may be similar to the capability enquiry message 412 and/or the capability enquiry message 1110. Aspects of the segmentation indicator 1412 may be similar to the segmentation indicator 414 and/or the segmentation indicator 1112.

The UE 1404 may then generate an uplink control message. For example, the UE 1404 may perform a generation procedure 1420 to generate a first UE capability information message 1422 for transmitting without segmentation. For example, the UE 1404 may limit the amount of uplink control information encoded in the first UE capability information message 1422 so that a size of the first UE capability information message 1422 is less than or equal to a packet size limit. In the illustrated example of FIG. 14, the UE 1404 generates the first UE capability information message 1422 for transmission without segmentation based on an evaluation of network behavior. For example, the UE 1404 may determine that the count of connection releases (e.g., the connection release counter) is greater than the release threshold. The UE 1404 may then transmit the first UE capability information message 1422 that is received by the network entity 1402. The UE 1404 may transmit the first UE capability information message 1422 without segmentation. For example, the UE 1404 may transmit the first UE capability information message 1422 via a “UECapabilityInformation” message.

In the illustrated example of FIG. 14, the UE 1404 performs a monitoring procedure 1430 to monitor for an occurrence of an update triggering event. For example, at 1432, the UE 1404 may detect a serving cell change. In some examples, the UE may detect the serving cell change based on a change of the serving cell. In some examples, the UE may detect the serving cell change based on a change in a tracking area (e.g., a change in a TAI and/or a change in RA). In some examples, the UE may detect the serving cell change based on a change of a serving network node. In some examples, the UE may detect the serving cell change after performing a mobility procedure.

As shown in FIG. 14, the UE 1404 may transmit an update message 1434 that is obtained by the network entity 1402. The update message 1434 may inform the network entity 1402 that the UE 1404 wants to resynchronize its capabilities with the network. For example, based on the update message 1434, the network entity 1402 and the UE 1404 may perform a capability resynchronization procedure 1436. For example, the network entity 1402 may output a capability enquiry message 1438 in response to the update message 1434. The capability enquiry message 1438 may include a segmentation indicator 1440 indicating that message segmentation is enabled. Aspects of the capability enquiry message 1438 and the segmentation indicator 1440 may be similar to the capability enquiry message 1410 and the segmentation indicator 1412, respectively.

In the illustrated example of FIG. 14, the UE 1404 performs a generation procedure 1450 to generate a second UE capability information message 1452. The UE 1404 may generate the second UE capability information message 1452 in response to the capability enquiry message 1438. The UE 1404 may generate the second UE capability information message 1452 without being constrained by the packet size limit for one packet. In some such examples, the amount of uplink control information that the UE 1404 may encode in the second UE capability information message 1452 may be larger than the amount of uplink control information that UE 1404 may encode in the first UE capability information message 1422. In some scenarios, the UE 1404 may be able to provide additional capability information that the UE 1404 was previously unable to provide. The UE 1404 may then transmit the second UE capability information message 1452 via segment messages 1454 that are obtained by the network entity 1402. Aspects of the segment messages 1454 may be similar to the segment messages 442 of FIG. 4 and/or the segment messages 1136 of FIG. 11.

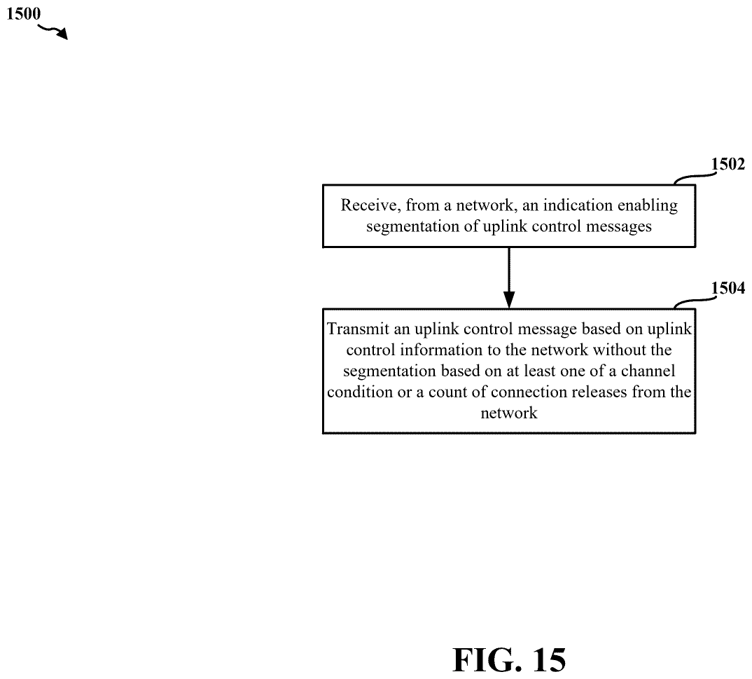

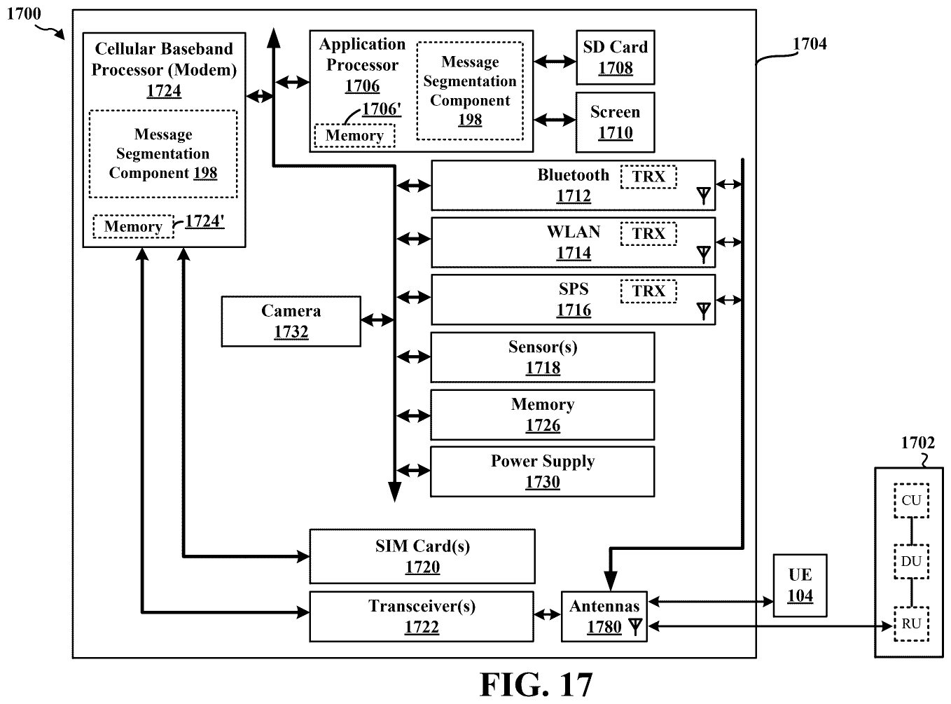

FIG. 15 is a flowchart 1500 of a method of wireless communication. The method may be performed by a UE (e.g., the UE 104, and/or an apparatus 1704 of FIG. 17). The method may facilitate improving communication performance in scenarios in which message segmentation is permitted, but channel conditions or network behaviors may reduce the benefits of transmitting an uplink control message with segmentation.

At 1502, the UE receives, from a network, an indication enabling segmentation of uplink control messages, as described in connection with at least the segmentation indicator 414 of FIG. 4, the segmentation indicator 812 of FIG. 8, the segmentation indicator 1112 of FIG. 11, and/or the segmentation indicator 1212 of FIG. 12. The receiving of the indication, at 1502, may be performed by a cellular RF transceiver 1722/the message segmentation component 198 of the apparatus 1704 of FIG. 17.

At 1504, the UE transmits an uplink control message based on uplink control information to the network without the segmentation based on at least one of a channel condition or a count of connection releases from the network, the uplink control information having a size that is greater than a maximum PDCP SDU size, as described in connection with at least the reduction procedure 842 of FIG. 8, the first UE capability information message 922 of FIG. 9, the UE capability information message 1150 of FIG. 11, and/or the UE capability information message 1236 of FIG. 12. The transmitting of the uplink control message without segmentation, at 1504, may be performed by the cellular RF transceiver 1722/the message segmentation component 198 of the apparatus 1704 of FIG. 17.

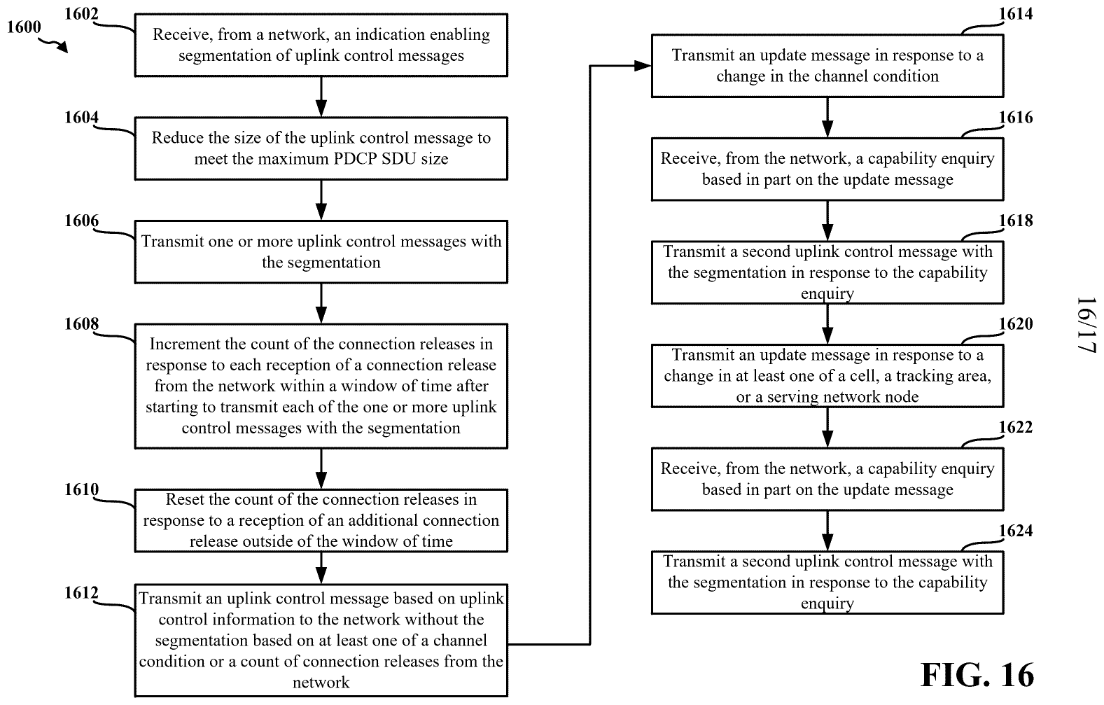

FIG. 16 is a flowchart 1600 of a method of wireless communication. The method may be performed by a UE (e.g., the UE 104, and/or an apparatus 1704 of FIG. 17). The method may facilitate improving communication performance in scenarios in which message segmentation is permitted, but channel conditions or network behaviors may reduce the benefits of transmitting an uplink control message with segmentation.

At 1602, the UE receives, from a network, an indication enabling segmentation of uplink control messages, as described in connection with at least the segmentation indicator 414 of FIG. 4, the segmentation indicator 812 of FIG. 8, the segmentation indicator 1112 of FIG. 11, and/or the segmentation indicator 1212 of FIG. 12. The receiving of the indication, at 1602, may be performed by a cellular RF transceiver 1722/the message segmentation component 198 of the apparatus 1704 of FIG. 17. At 1612, the UE transmits an uplink control message based on uplink control information to the network without the segmentation based on at least one of a channel condition or a count of connection releases from the network, the uplink control information having a size that is greater than a maximum PDCP SDU size, as described in connection with at least the reduction procedure 842 of FIG. 8, the first UE capability information message 922 of FIG. 9, the UE capability information message 1150 of FIG. 11, and/or the UE capability information message 1236 of FIG. 12. The transmitting of the uplink control message without segmentation, at 1612, may be performed by the cellular RF transceiver 1722/the message segmentation component 198 of the apparatus 1704 of FIG. 17.

In some examples, the indication (e.g., at 1602) may enable RRC message segmentation. In some such examples, the uplink control message (e.g., at 1604) may include UE capability information having an encoded RRC message size that is reduced to meet the maximum PDCP SDU size in order to transmit the UE capability information without the segmentation.

In some examples, the UE may reduce the size of the uplink control message. For example, at 1604, the UE may reduce the size of the uplink control message to meet the maximum PDCP SDU size, as described in connection with at least the reduction procedure 842 of FIG. 8. The reducing of the size of the uplink control message, at 1604, may be performed by the cellular RF transceiver 1722/the message segmentation component 198 of the apparatus 1704 of FIG. 17.

In some examples, the UE may transmit the uplink control message to the network without the segmentation in response to the channel condition meeting a threshold, as described in connection with at the second test 714 of FIG. 7 and/or the second test 834 of FIG. 8. In some examples, meeting the threshold is based on an RSRP being less than an RSRP threshold, as described in connection with the first channel condition test 722 of FIG. 7. In some examples, meeting the threshold is based on an average pathloss being greater than a pathloss threshold, as described in connection with the second channel condition test 724 of FIG. 7. In some examples, meeting threshold is based on an SNR being less than an SNR threshold, as described in connection with the third channel condition test 726 of FIG. 7. In some examples, meeting the threshold is based on respective measurements satisfying at least one of the RSRP threshold, the pathloss threshold, and the SNR threshold.

In some examples, after determining that the channel condition is poor, the UE may perform a monitoring procedure to monitor for an occurrence of an update triggering event. For example, at 1614, the UE may transmit an update message in response to a change in the channel condition, as described in connection with the update message 934 of FIG. 9. The transmitting of the update message, at 1614, may be performed by the cellular RF transceiver 1722/the message segmentation component 198 of the apparatus 1704 of FIG. 17.

At 1616, the UE may receive, from the network, a capability enquiry based in part on the update message, as described in connection with the capability enquiry message 938 of FIG. 9. The receiving of the capability enquiry, at 1616, may be performed by the cellular RF transceiver 1722/the message segmentation component 198 of the apparatus 1704 of FIG. 17.

At 1618, the UE may transmit a second uplink control message with the segmentation in response to the capability enquiry, as described in connection with the second UE capability information message 952 and the segment messages 954 of FIG. 9. The transmitting of the second uplink control message with the segmentation, at 1618, may be performed by the cellular RF transceiver 1722/the message segmentation component 198 of the apparatus 1704 of FIG. 17.

In some examples, the UE may transmit the uplink control message to the network without the segmentation in response to the count of the connection releases from the network being higher than a release threshold, as described in connection with at least the UE capability information message 1150 of FIG. 11, the UE capability information message 1236 of FIG. 12, and/or the first UE capability information message 1422 of FIG. 14.

For example, at 1606, the UE may transmit one or more uplink control messages with the segmentation, as described in connection with at least UE capability information associated with the instances of the table 1300 of FIG. 13. The transmitting of the one or more uplink control messages with the segmentation, at 1606, may be performed by the cellular RF transceiver 1722/the message segmentation component 198 of the apparatus 1704 of FIG. 17.

At 1608, the UE may increment the count of the connection releases in response to each reception of a connection release from the network within a window of time after transmitting one of the one or more uplink control messages with the segmentation, where the UE transmits the uplink control message without the segmentation in response to the count of the connection releases being higher than the release threshold, as described in connection with the increment procedure 1148 of FIG. 11 and the increment procedure 1230 of FIG. 12. The incrementing of the count of the connection releases, at 1608, may be performed by the cellular RF transceiver 1722/the message segmentation component 198 of the apparatus 1704 of FIG. 17.

At 1610, the UE may reset the count of the connection releases in response to a reception of an additional connection release outside of the window of time after transmitting one of the one or more uplink control messages, as described in connection with the reset procedure 1146 of FIG. 11 and/or the reset procedure 1232 of FIG. 12. The resetting of the count of the connection releases, at 1610, may be performed by the cellular RF transceiver 1722/the message segmentation component 198 of the apparatus 1704 of FIG. 17.

In some examples, after determining that the count of the connection releases from the network is higher than a release threshold, the UE may perform a monitoring procedure to monitor for an occurrence of an update triggering event. For example, at 1620, the UE may transmit an update message in response to a change in at least one of a cell, a tracking area, or a serving network node, as described in connection with update message 1434 of FIG. 14. The transmitting of the update message, at 1620, may be performed by the cellular RF transceiver 1722/the message segmentation component 198 of the apparatus 1704 of FIG. 17.

At 1622, the UE may receive, from the network, a capability enquiry based in part on the update message, as described in connection with the capability enquiry message 1438 of FIG. 14. The receiving of the capability enquiry, at 1622, may be performed by the cellular RF transceiver 1722/the message segmentation component 198 of the apparatus 1704 of FIG. 17.

At 1624, the UE may transmit a second uplink control message with the segmentation in response to the capability enquiry, as described in connection with the second UE capability information message 1452 and the segment messages 1454 of FIG. 14. The transmitting of the second uplink control message, at 1624, may be performed by the cellular RF transceiver 1722/the message segmentation component 198 of the apparatus 1704 of FIG. 17.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers (e.g., a cellular RF transceiver 1722). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize one or more antennas 1780 for communication. The cellular baseband processor 1724 communicates through transceiver(s) (e.g., the cellular RF transceiver 1722) via one or more antennas 1780 with the UE 104 and/or with an RU associated with a network entity 1702. The cellular baseband processor 1724 and the application processor 1706 may each include a computer-readable medium/memory, such as the on-chip memory 1724′, and the on-chip memory 1706′, respectively. The additional memory modules 1726 may also be considered a computer-readable medium/memory. Each computer-readable medium/memory (e.g., the on-chip memory 1724′, the on-chip memory 1706′, and/or the additional memory modules 1726) may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see the UE 350 of FIG. 3) and include the additional modules of the apparatus 1704.

As discussed supra, the message segmentation component 198 is configured to receive, from a network, an indication enabling segmentation of uplink control messages. The example message segmentation component 198 is also configured to transmit an uplink control message based on uplink control information to the network without the segmentation based on at least one of a channel condition or a count of connection releases from the network, the uplink control information having a size that is greater than a maximum packet data convergence protocol (PDCP) service data unit (SDU) size.

The message segmentation component 198 may be within the cellular baseband processor 1724, the application processor 1706, or both the cellular baseband processor 1724 and the application processor 1706. The message segmentation component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1704 may include a variety of components configured for various functions. For example, the message segmentation component 198 may include one or more hardware components that perform each of the blocks of the algorithm in the flowcharts of FIGS. 15 and/or 15.

In one configuration, the apparatus 1704, and in particular the cellular baseband processor 1724 and/or the application processor 1706, includes means for receiving, from a network, an indication enabling segmentation of uplink control messages. The example apparatus 1704 also includes means for transmitting an uplink control message based on uplink control information to the network without the segmentation based on at least one of a channel condition or a count of connection releases from the network, the uplink control information having a size that is greater than a maximum PDCP SDU size.

In another configuration, the example apparatus 1704 also includes means for reducing the size of the uplink control information to meet the maximum PDCP SDU size.

In another configuration, the example apparatus 1704 also includes means for transmitting an update message in response to a change in the channel condition. The example apparatus 1704 also includes means for receiving, from the network, a capability enquiry based in part on the update message. The example apparatus 1704 also includes means for transmitting a second uplink control message with the segmentation in response to the capability enquiry.

In another configuration, the example apparatus 1704 also includes means for transmitting one or more uplink control messages with the segmentation. The example apparatus 1704 also includes means for incrementing the count of the connection releases in response to each reception of a connection release from the network within a window of time after transmitting one of the one or more uplink control messages with the segmentation, wherein the UE transmits the uplink control message without the segmentation in response to the count of the connection releases being higher than the release threshold.

In another configuration, the example apparatus 1704 also includes means for transmitting an update message in response to a change in at least one of a cell, a tracking area, or a serving network node. The example apparatus 1704 also includes means for receiving, from the network, a capability enquiry based in part on the update message. The example apparatus 1704 also includes means for transmitting a second uplink control message with the segmentation in response to the capability enquiry.

The means may be the message segmentation component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

Aspects disclosed herein provide techniques for enabling a UE configured with message segmentation enabled to determine whether to employ message segmentation based on at least one of a channel condition or a count of connection releases from the network. For example, the UE may determine to skip employing message segmentation even when message segmentation is permitted based on a size of the uplink control message.

The aspects presented herein may enable a UE to improve communication performance in scenarios in which message segmentation is permitted. For example, in poor channel conditions, avoiding message segmentation may reduce overhead associated with uplink transmission, which can avoid or reduce delays associated with procedures based on information provided by the UE via an uplink control message, such as an attach procedure. Avoiding message segmentation in poor channel conditions may also reduce the possibility of connection drops due to a missing acknowledgement message from the network after the UE transmits the uplink control message.

In examples in which the UE avoids message segmentation based on a count of connection release messages, the UE may be able to improve communication performance by maintaining a connection with the network. For example, if the network is performing immediate connection releases after the UE transmits a segment message, the UE may have the ability to determine, based on the count of connection release messages, that the network is unable to handle message segmentation. In such examples, the UE may skip message segmentation when communicating with the network to maintain the connection with the network.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, including: receiving, from a network, an indication enabling segmentation of uplink control messages; and transmitting an uplink control message based on uplink control information to the network without the segmentation based on at least one of a channel condition or a count of connection releases from the network, the uplink control information having a size that is greater than a maximum packet data convergence protocol (PDCP) service data unit (SDU) size.
Aspect 2 is the method of aspect 1, further including: reducing the size of the uplink control information to meet the maximum PDCP SDU size.
Aspect 3 is the method of any of aspects 1 and 2, further including that the uplink control message is transmitted to the network without the segmentation in response to the channel condition meeting a threshold.
Aspect 4 is the method of any of aspects 1 to 3, further including that meeting the threshold is based on one or more of: a reference signal received power (RSRP) being less than an RSRP threshold, an average pathloss being greater than a pathloss threshold, or a signal to noise ratio (SNR) being less than an SNR threshold.
Aspect 5 is the method of any of aspects 1 to 4, further including that the uplink control message is a first uplink control message, the method further including: transmitting an update message in response to a change in the channel condition; receiving, from the network, a capability enquiry based in part on the update message; and transmitting a second uplink control message with the segmentation in response to the capability enquiry.
Aspect 6 is the method of any of aspects 1 and 2, further including that the uplink control message is transmitted to the network without the segmentation in response to the count of the connection releases from the network being higher than a release threshold.
Aspect 7 is the method of any of aspects 1 to 6, further including: transmitting one or more uplink control messages with the segmentation; and incrementing the count of the connection releases in response to each reception of a connection release from the network within a window of time after transmitting one of the one or more uplink control messages with the segmentation, where the UE transmits the uplink control message without the segmentation in response to the count of the connection releases being higher than the release threshold.
Aspect 8 is the method of any of aspects 1 to 7, further including: resetting the count of the connection releases in response to a reception of an additional connection release outside of the window of time after transmitting one of the one or more uplink control messages.
Aspect 9 is the method of any of aspects 1 to 8, further including that the uplink control message is a first uplink control message, the method further including: transmitting an update message in response to a change in at least one of a cell, a tracking area, or a serving network node; receiving, from the network, a capability enquiry based in part on the update message; and transmitting a second uplink control message with the segmentation in response to the capability enquiry.
Aspect 10 is the method of any of aspects 1 to 9, further including that the indication enables radio resource control (RRC) message segmentation.
Aspect 11 is the method of any of aspects 1 to 10, further including that the uplink control message includes UE capability information having an encoded RRC message size that is reduced to meet the maximum PDCP SDU size in order to transmit the UE capability information without the segmentation.
Aspect 12 is an apparatus for wireless communication at a UE including at least one processor coupled to a memory and configured to implement any of aspects 1 to 11.

In aspect 13, the apparatus of aspect 12 further includes at least one antenna coupled to the at least one processor.

In aspect 14, the apparatus of aspect 12 or 13 further includes a transceiver coupled to the at least one processor.
Aspect 15 is an apparatus for wireless communication including means for implementing any of aspects 1 to 11.

In aspect 16, the apparatus of aspect 15 further includes at least one antenna coupled to the means to perform the method of any of aspects 1 to 11.

In aspect 17, the apparatus of aspect 15 or 16 further includes a transceiver coupled to the means to perform the method of any of aspects 1 to 11.
Aspect 18 is a non-transitory computer-readable storage medium storing computer executable code, where the code, when executed, causes a processor to implement any of aspects 1 to 11.

1. An apparatus for wireless communication at a user equipment (UE), comprising:
memory; and
at least one processor coupled to the memory and configured to:
receive, from a network, an indication enabling segmentation of uplink control messages; and
transmit an uplink control message based on uplink control information to the network without the segmentation based on at least one of a channel condition or a count of connection releases from the network, the uplink control information having a size that is greater than a maximum packet data convergence protocol (PDCP) service data unit (SDU) size.

2. The apparatus of claim 1, wherein the at least one processor is further configured to:
reduce the size of the uplink control information to meet the maximum PDCP SDU size.

3. The apparatus of claim 1, wherein the at least one processor is configured to:
transmit the uplink control message to the network without the segmentation in response to the channel condition meeting a threshold.

4. The apparatus of claim 3, wherein to meet the threshold, the at least one processor is configured to determine at least one of:
a reference signal received power (RSRP) being less than an RSRP threshold,
an average pathloss being greater than a pathloss threshold, or
a signal to noise ratio (SNR) being less than an SNR threshold.

5. The apparatus of claim 3, wherein the uplink control message is a first uplink control message, and the at least one processor is further configured to:
transmit an update message in response to a change in the channel condition;
receive, from the network, a capability enquiry based in part on the update message; and
transmit a second uplink control message with the segmentation in response to the capability enquiry.

6. The apparatus of claim 1, wherein the at least one processor is configured to:
transmit the uplink control message to the network without the segmentation in response to the count of the connection releases from the network being higher than a release threshold.

7. The apparatus of claim 6, wherein the at least one processor is further configured to:
transmit one or more uplink control messages with the segmentation; and
increment the count of the connection releases in response to each reception of a connection release from the network within a window of time after transmitting one of the one or more uplink control messages with the segmentation, wherein the UE transmits the uplink control message without the segmentation in response to the count of the connection releases being higher than the release threshold.

8. The apparatus of claim 7, wherein the at least one processor is further configured to:
reset the count of the connection releases in response to a reception of an additional connection release outside of the window of time after transmitting one of the one or more uplink control messages.

9. The apparatus of claim 6, wherein the uplink control message is a first uplink control message, and the at least one processor is further configured to:
transmit an update message in response to a change in at least one of a cell, a tracking area, or a serving network node;
receive, from the network, a capability enquiry based in part on the update message; and
transmit a second uplink control message with the segmentation in response to the capability enquiry.

10. The apparatus of claim 1, wherein the indication enables radio resource control (RRC) message segmentation.

11. The apparatus of claim 10, wherein the uplink control message includes UE capability information having an encoded RRC message size that is reduced to meet the maximum PDCP SDU size in order to transmit the UE capability information without the segmentation.

12. The apparatus of claim 1, further comprising a transceiver coupled to the at least one processor.

13. A method of wireless communication at a user equipment (UE), comprising:
receiving, from a network, an indication enabling segmentation of uplink control messages; and
transmitting an uplink control message based on uplink control information to the network without the segmentation based on at least one of a channel condition or a count of connection releases from the network, the uplink control information having a size that is greater than a maximum packet data convergence protocol (PDCP) service data unit (SDU) size.

14. The method of claim 13, further comprising:
reducing the size of the uplink control information to meet the maximum PDCP SDU size.

15. The method of claim 13, wherein the uplink control message is transmitted to the network without the segmentation in response to the channel condition meeting a threshold.

16. The method of claim 15, wherein meeting the threshold is based on one or more of:
a reference signal received power (RSRP) being less than an RSRP threshold,
an average pathloss being greater than a pathloss threshold, or
a signal to noise ratio (SNR) being less than an SNR threshold.

17. The method of claim 15, wherein the uplink control message is a first uplink control message, the method further comprising:
transmitting an update message in response to a change in the channel condition;
receiving, from the network, a capability enquiry based in part on the update message; and
transmitting a second uplink control message with the segmentation in response to the capability enquiry.

18. The method of claim 13, wherein the uplink control message is transmitted to the network without the segmentation in response to the count of the connection releases from the network being higher than a release threshold.

19. (canceled)

20. The method of claim 18, further comprising:
resetting the count of the connection releases in response to a reception of an additional connection release outside of a window of time after transmitting one of one or more uplink control messages.

21-23. (canceled)

24. An apparatus for wireless communication at a user equipment (UE), comprising:
means for receiving, from a network, an indication enabling segmentation of uplink control messages; and
means for transmitting an uplink control message based on uplink control information to the network without the segmentation based on at least one of a channel condition or a count of connection releases from the network, the uplink control information having a size that is greater than a maximum packet data convergence protocol (PDCP) service data unit (SDU) size.

25-30. (canceled)
